(19) United States
(12) Patent Application Publication
(10) Pub. No.: US 2026/0106652 A1
(43) Pub. Date: Apr. 16, 2026

(54) METHODS AND SYSTEMS FOR SELECTION AND REPORTING OF NEAR-FIELD PRECODERS

(71) Applicants: CENTRE OF EXCELLENCE IN WIRELESS TECHNOLOGY, Chennai (IN); INDIAN INSTITUTE OF TECHNOLOGY MADRAS (IIT MADRAS), Chennai (IN)

(72) Inventors: Pardhasarathy Jyothi, Chennai (IN); Dhivagar BASKARAN, Chennai (IN); Jutke Goutham, Chennai (IN); Jeniston Deviraj Klutto MILLETH, Chennai (IN); Bhaskar RAMAMURTHI, Chennai (IN)

(73) Assignees: CENTRE OF EXCELLENCE IN WIRELESS TECHNOLOGY, Chennai (IN); INDIAN INSTITUTE OF TECHNOLOGY MADRAS (IIT MADRAS), Chennai (IN)

(21) Appl. No.: 19/357,852

(22) Filed: Oct. 14, 2025

(30) Foreign Application Priority Data
Oct. 11, 2024 (IN) 202441077293

(51) Int. Cl. H04B 7/0456; H04L 5/00; H04L 27/26

(52) U.S. Cl. CPC H04B 7/0456; H04L 5/0007; H04L 27/261

(57) ABSTRACT

The present application discloses a method of using a precoder matrix for wireless signal transmission in an OFDM based communication systems in accordance with an embodiment of the present disclosure. The method comprises: signaling by a Base station (BS), a configuration for receiving a set of reference signals by a UE for estimating the wireless channel between the BS and the UE, signaling by the BS, a configuration of at least one of a set of first basis vectors, a set of second basis vectors, a set of third basis vectors and a set of fourth basis vectors to the UE explicitly or implicitly, receiving by the BS, at least one of a subset of the first basis vectors, a subset of the second basis vectors, a first subset of the third basis vectors and a first subset of the fourth basis vectors, determining by the BS, a set of second subset of third basis vectors based on the first subset of third basis vectors and a set of second subset of fourth basis vectors based on the first subset of fourth basis vectors, determining by the BS, a precoder matrix based on the subset of first basis vectors, the subset of second basis vectors, the subset of third basis vectors and the subset of fourth basis vectors, obtaining by the BS, a precoded wireless signal by precoding a wireless signal using the precoder matrix and transmitting by the BS, the precoded wireless signal.

### CROSS-REFERENCE

This application claims the benefit of priority under 35 U.S.C. § 119 from Indian Patent Application No. 202441077293 which is hereby incorporated by reference as if set forth in its entirety herein.

### FIELD OF THE INVENTION

The present disclosure, generally, relates to wireless communication systems and more particularly to methods and procedures for selection and reporting of near field pre-coders in multiple-input-multiple output (MIMO) communication.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Many improvements have been made to the well-established multiple-input multiple-output (MIMO) technology with each new generation of wireless networks. Long-term evolution (LTE) in its fourth iteration introduced a number of transmission and channel state information (CSI) acquisition mechanisms. With the introduction of beam management techniques and modified discrete Fourier transform (DFT) codebooks to enable near-optimal input from the user equipment (UE), the fifth generation new radio (NR) introduced the notion of antenna arrays by expanding the advanced releases of LTE. Large antenna arrays are presently being investigated by the 3GPP for potential incorporation into future MIMO developments in sixth generation networks.

Massive MIMO antenna arrays are used at the base station (gNB) in contemporary wireless communication systems, such as 5G, to facilitate high-capacity data transmission via a process known as precoding. To overcome the distorting effects of the wireless channel, precoding entails pre-processing signals prior to transmission in order to concentrate energy towards a particular user. Operating in the antenna's near-field has become more common as a result of the installation of incredibly large antenna arrays and the use of higher frequency bands, such as millimeter-wave. Radio waves need to be precisely modeled as spherical waves in the near-field because the near-field involves complex, distance-dependent curvature, and hence more sophisticated spherical-wave models are required for accurate beamforming. In this situation, the ideal precoder is dependent not only on the angle but also, and this is crucial, on the user's distance from the antenna. Performance degradation for near-field users is severe due to the inefficiency of current 3GPP standards in identifying and reporting precoders capable of accurately shaping these spherical wave fronts.

Thus, precoding in MIMO systems are required to counteract the negative effects of the wireless channel for e.g. signal fading, reflections, and interference even before the signal is transmitted. Precoders are generally selected using a codebook based precoding scheme in mobile communication standards like 4G and 5G. The base station and User Equipment (UE) both have access to an identical, predefined set of possible precoders, which is known as a codebook. Each precoder in this codebook is a specific beam shape or transmission pattern, identified by an index number. Direct Channel State Information (CSI) based precoding is an alternative to codebook-based precoding. Using this method, the UE measures the channel and sends a more comprehensive representation of the channel matrix back to the base station by quantizing it rather than choosing an index from a pre-established codebook. The base station can then calculate a custom built precoder that is ideal for the current channel conditions after receiving a CSI feedback.

Channels with a strong Line-of-Sight (LoS) path, which are typical when a user is near the base station, present a significant challenge. As the signal follows a single dominant path, these channels are referred to as “rank-deficit.” Spatial multiplexing, a technique that transmits multiple data streams (layers) simultaneously, is inefficient in these situations, according to current 3GPP specifications. According to the standard, the entire antenna panel must transmit all data layers. This results in high inter-layer interference in a low-rank channel, which forces the system to revert to a lower rank (fewer data streams) in order to maintain a reliable link. This results in a significant disadvantage, as the highest supported Channel Quality Indicator (CQI) value caps the per-layer spectral efficiency, and hence the system cannot take advantage of a very high capacity channel. As a result, a large amount of potential data throughput is wasted as the base station is compelled to perform lower-rank transmissions.

Thus, there is a need in the art for improved methods that can address the unique challenges of both near-field communication and spatial multiplexing in low-rank channels, thereby unlocking the full potential of MIMO systems.

There is also a need in the art for selection of correct precoders for a user in the near-field. The techniques described herein enable to shape a spherical wavefront, accounting for not just the angle to the user, but also the specific distance. Once the correct near-field precoder is determined, there is a need for an efficient way for the user's device (UE) to communicate this choice back to the base station.

The existing reporting mechanisms are designed for the simpler, far-field codebooks. Thus, there is a need in the art for an efficient feedback procedure to handle the more complex information associated with these new spherical-wave-based precoders.

There is a further need in the art for improved techniques of selecting sub-panels across layers to overcome limitations in spectral efficiency.

### SUMMARY OF THE INVENTION

The summary is provided to introduce embodiments related to methods of wireless communication, and the embodiments are further described below in the detailed description. This summary is not intended to identify essential features of the claimed subject matter nor is it intended for use in determining or limiting the scope of the claimed subject matter.

Embodiment of the present disclosure features a method of using a precoder matrix for wireless signal transmission in an OFDM based communication systems. The method comprises: signaling by a Base station (BS), a configuration for receiving a set of reference signals by a UE for estimating the wireless channel between the BS and the UE, signaling by the BS, a configuration of at least one of a set of first basis vectors, a set of second basis vectors, a set of third basis vectors and a set of fourth basis vectors to the UE explicitly or implicitly, receiving by the BS, at least one of a subset of the first basis vectors, a subset of the second basis vectors, a first subset of the third basis vectors and a first subset of the fourth basis vectors, determining by the BS, a set of second subset of third basis vectors based on the first subset of third basis vectors and a set of second subset of fourth basis vectors based on the first subset of fourth basis vectors, determining by the BS, a precoder matrix based on the subset of first basis vectors, the subset of second basis vectors, the subset of third basis vectors and the subset of fourth basis vectors, obtaining by the BS, a precoded wireless signal by precoding the wireless signal using the precoder matrix and transmitting by the BS, the precoded wireless signal.

In an embodiment, configuration for receiving the set of reference signals comprises at least one of: a number of antenna ports at the BS, wherein an antenna port is associated with an antenna port index, the mapping between an antenna port index at the BS and a reference signal from the set of reference signals, wherein a reference signal from the set of reference signals is transmitted using the physical antenna elements associated with the antenna port, the dimension of the antenna panel at the BS comprising of the number of antenna ports in the first dimension (N₁), the number of antenna ports in the second dimension (N₂), an oversampling factor corresponding to the first dimension (O₁) and an oversampling factor corresponding to the second dimension (O₂), the number of sub-panels for precoder computation, the number of sub-panels in the first dimension

$$( {N}_{1}^{SP} )$$

and the number of sub-panels in the second dimension

$$( {N}_{2}^{SP} ) ,$$

wherein a sub-panel is associated with a sub-panel index, the reference sub-panel index among the set of sub-panel indices, the dimension of the at least one sub-panel at the BS comprising of the number of antenna ports per sub-panel in the first dimension

$$( {N}_{1}^{′} ) ,$$

the number of antenna ports per sub-panel in the second dimension

$$( {N}_{2}^{′} ) ,$$

an oversampling factor per sub-panel corresponding to the first dimension

$$( {O}_{1}^{′} )$$

and an oversampling factor sub-panel corresponding to the second dimension

$$( {O}_{2}^{′} ) ,$$

and the association between a subset of antenna port indices and a sub-panel index.

The BS determines the precoder corresponding to the reference sub-panel index based on the subset of first basis vectors, the subset of second basis vectors, the first subset of third basis vectors and the first subset of fourth basis vectors, wherein each second subset in the set of second subset of third basis vectors is associated with a sub-panel index and wherein each second subset in the set of second subset of fourth basis vectors is associated with a sub-panel index in accordance with an embodiment of the present disclosure.

Further, the BS determines the precoder corresponding to a sub-panel based on the subset of first basis vectors, the subset of second basis vectors, the second subset of third basis vectors associated with the sub-panel and the second subset of fourth basis vectors associated with the sub-panel.

Embodiment of the present disclosure features a method of using a precoder matrix for wireless signal transmission in an OFDM based communication systems in accordance with another embodiment of the present disclosure. The method comprises: receiving by a UE, a configuration signal for receiving a set of reference signals by a UE for estimating the wireless channel between the BS and the UE, receiving by the UE, a configuration signal of at least one of a set of first basis vectors, a set of second basis vectors, a set of third basis vectors and a set of fourth basis vectors, receiving by the UE, the configured set of reference signals from the BS, determining by the UE, a subset of first basis vectors, a subset of second basis vectors, a first subset of third basis vectors and a first subset of fourth basis vectors and reporting by the UE, at least one of the determined subset of first basis vectors, the subset of second basis vectors, the first subset of third basis vectors and the first subset of fourth basis vectors explicitly or implicitly.

In an embodiment, the configuration for receiving the set of reference signals comprises at least one of: a number of antenna ports at the BS, wherein an antenna port is associated with an antenna port index, the mapping between an antenna port index at the BS and a reference signal from the set of reference signals, wherein a reference signal from the set of reference signals is transmitted using the physical antenna elements associated with the antenna port, the dimension of the antenna panel at the BS comprising of the number of antenna ports in the first dimension (N₁), the number of antenna ports in the second dimension (N₂), an oversampling factor corresponding to the first dimension (O₁) and an oversampling factor corresponding to the second dimension (O₂), the number of sub-panels for precoder computation, the number of sub-panels in the first dimension

$$( {N}_{1}^{SP} )$$

and the number of sub-panels in the second dimension

$$( {N}_{2}^{SP} ) ,$$

wherein a sub-panel is associated with a sub-panel index, the reference sub-panel index among the set of sub-panel indices, the dimension of the at least one sub-panel at the BS comprising of the number of antenna ports per sub-panel in the first dimension

$$( {N}_{1}^{′} ) ,$$

the number of antenna ports per sub-panel in the second dimension

$$( {N}_{2}^{′} ) ,$$

an oversampling factor per sub-panel corresponding to the first dimension

$$( {O}_{1}^{′} )$$

and an oversampling factor sub-panel corresponding to the second dimension

$$( {O}_{2}^{′} ) ,$$

and the association between a subset of antenna port indices and a sub-panel index.

The UE determines at least one of the set of first basis vectors, the set of second basis vectors based on at least one of N₁, N₂, N′₁, N′₂, O₁ and O₂. The UE determines at least one of the set of third basis vectors, the set of fourth basis vectors based on at least one of N′₁, N′₂, O′₁ and O′₂. The UE determines the subset of first basis vectors and the subset of second basis vectors based on the received set of reference signals. The UE further determines the first subset of third basis vectors and the first subset of fourth basis vectors based on the received set of reference signals corresponding to the reference sub-panel index.

In an embodiment, the UE reports the indices corresponding to the subset of first basis vectors, the indices corresponding to the subset of second basis vectors, the indices corresponding to the first subset of third basis vectors and the indices corresponding to the first subset of fourth basis vectors to the BS. The set of first basis vectors, the set of second basis vectors, the set of third basis vectors and the set of fourth basis vectors are DFT based vectors, wherein each second subset in the set of second subset of third basis vectors is associated with a sub-panel index and wherein each second subset in the set of second subset of fourth basis vectors is associated with a sub-panel index.

Embodiment of the present disclosure features a method for spatial multiplexing a plurality of wireless signals in an OFDM based wireless communication systems in accordance with another embodiment of the present disclosure. The method comprises: signaling by the BS, a configuration of sub-panels to a UE, wherein a sub-panel is associated with a sub-panel index, receiving by the BS, at least one of a layer index and a precoder matrix associated with a sub-panel and transmitting by the BS, a plurality of wireless signals based on the layer index and the precoder matrix associated with the sub-panel. The metric is computed based on at least one of a set of spatial domain (SD) basis vectors of a sub-panel, the signal to noise ratio (SINR) of a sub-panel, the sub-panel index and the cardinality of the plurality of wireless signals.

Embodiment of the present disclosure features a method for spatial multiplexing a plurality of wireless signals in an OFDM based wireless communication systems in accordance with another embodiment of the present disclosure. The method comprises: receiving by the UE, a configuration of sub-panels, wherein a sub-panel is associated with a sub-panel index, determining by the UE, at least one metric associated with a sub-panel, determining by the UE, at least one layer index associated with a sub-panel based on the at least one metric, determining by the UE, a precoder matrix associated with each sub-panel based on the at least one layer index of the sub-panel and reporting by the UE, at least one of the layer index and the precoder matrix of the sub-panel to the BS.

The metric is computed based on at least one of a set of spatial domain (SD) basis vectors of a sub-panel, the signal to noise ratio (SINR) associated with a sub-panel, the sub-panel index and the cardinality of the plurality of wireless signals. The UE determines the layer index between two sub-panels to be the same when at least K SD basis vectors are common between the two sub-panels in accordance with an embodiment of the present disclosure.

Embodiment of the present disclosure features an apparatus for using a precoder matrix for wireless signal transmission in an OFDM based communication systems comprising a processor, a memory storing program instructions which, when executed by the processor, causes the processor to: signal, a configuration for receiving a set of reference signals by a UE for estimating the wireless channel between the BS and the UE, signal, a configuration of at least one of a set of first basis vectors, a set of second basis vectors, a set of third basis vectors and a set of fourth basis vectors to the UE explicitly or implicitly, receive, at least one of a subset of the first basis vectors, a subset of the second basis vectors, a first subset of the third basis vectors and a first subset of the fourth basis vectors, determine, a set of second subset of third basis vectors based on the first subset of third basis vectors and a set of second subset of fourth basis vectors based on the first subset of fourth basis vectors, determine, a precoder matrix based on the subset of first basis vectors, the subset of second basis vectors, the subset of third basis vectors and the subset of fourth basis vectors, obtain, a precoded wireless signal by precoding a wireless signal using the precoder matrix and transmit, the precoded wireless signal.

Embodiment of the present disclosure features an apparatus for using a precoder matrix for wireless signal transmission in an OFDM based communication systems comprising: a processor, a memory storing program instructions which, when executed by the processor, causes the processor to: receive, a configuration signal for receiving a set of reference signals by a UE for estimating the wireless channel between the BS and the UE, receive, a configuration signal of at least one of a set of first basis vectors, a set of second basis vectors, a set of third basis vectors and a set of fourth basis vectors, receive, the configured set of reference signals from the BS, determine, a subset of first basis vectors, a subset of second basis vectors, a first subset of third basis vectors and a first subset of fourth basis vectors and report, at least one of the determined subset of first basis vectors, the subset of second basis vectors, the first subset of third basis vectors and the first subset of fourth basis vectors explicitly or implicitly.

Embodiment of the present disclosure features an apparatus for using a precoder matrix for wireless signal transmission in an OFDM based communication systems comprising: a processor, a memory storing program instructions which, when executed by the processor, causes the processor to: receive, at least one of a layer index and a precoder matrix associated with a sub-panel and transmit by the BS, a plurality of wireless signals based on the layer index and the precoder matrix associated with the sub-panel.

Embodiment of the present disclosure features an apparatus for using a precoder matrix for wireless signal transmission in OFDM based communication systems comprising: a processor, a memory storing program instructions which, when executed by the processor, causes the processor to: receive, a configuration of sub-panels, wherein a sub-panel is associated with a sub-panel index, determine, at least one metric associated with a sub-panel, determine, at least one layer index associated with a sub-panel based on the at least one metric, determine, a precoder matrix associated with each sub-panel based on the at least one layer index of the sub-panel and report, at least one of the layer index and the precoder matrix of the sub-panel to the BS.

The above summary is provided merely for the purpose of summarizing some example embodiments to provide a basic understanding of some embodiments of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, embodiments, and advantages of the subject will become apparent from the description, the drawings, and the claims.

### BRIEF DESCRIPTION OF THE DRAWINGS

The accompanying drawings are included to provide a further understanding of the present disclosure, and are incorporated in and constitute a part of this specification.

FIG. 1 illustrates a general representation of the precoding process in a 2×2 MIMO system;

FIG. 2 illustrates an example of an antenna panel of 4×8 dimension and antenna indexing in a 8×8 antenna panel;

FIG. 3 represents a line of sight (LoS) channel between a transmitter and a receiver in a wireless communication system in accordance with an embodiment of the present disclosure;

FIG. 4 is a graphical representation of linear and non-linear phase variation in a multi path channel for a UE in near field and far field across the elements of an antenna array;

FIG. 5 illustrates a spatial domain basis compression for sub-panel based precoder design in accordance with an embodiment of the present disclosure;

FIG. 6 illustrates an actual phase variation of a multi-path with respect to antenna index in accordance with an embodiment of the present disclosure;

FIG. 7 illustrates a method for designing precoder in a near field according to an embodiment of the present disclosure;

FIG. 8 illustrates a cluster-based method for designing precoder in a near field according to an embodiment of the present disclosure;

FIG. 9 illustrates a graphical representation of spatial domain basis reported as a cluster of DFT vectors in accordance with an embodiment of the present disclosure;

FIG. 10 illustrates methods for spatial multiplexing using sub-panels in accordance with an embodiment of the present disclosure;

FIG. 11 illustrates a fixed mapping between a layer index and the sub-panels for any given rank in accordance with an embodiment of the present disclosure;

FIG. 12 is an example wireless communication system configured to perform the methods described in the present disclosure;

FIG. 13 illustrates a method of using a precoder matrix for wireless signal transmission in an OFDM based communication systems in accordance with an embodiment of the present disclosure;

FIG. 14 illustrates a method of using a precoder matrix for wireless signal transmission in an OFDM based communication systems in accordance with another embodiment of the present disclosure;

FIG. 15 illustrates a method of using a precoder matrix for wireless signal transmission in an OFDM based communication systems in accordance with another embodiment of the present disclosure;

FIG. 16 illustrates a method of using a precoder matrix for wireless signal transmission in an OFDM based communication systems in accordance with another embodiment of the present disclosure.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. The terms “antenna”, “antenna element”, “antenna element group”, “antenna port” and “Transmission Reception Unit (TxRU)” are used interchangeably in this report.

Exemplary embodiments will now be described more fully hereinafter with reference to the accompanying drawings, in which exemplary embodiments are shown. This disclosure may however, be embodied in many different forms and should not be construed as limited to the embodiments set forth herein.

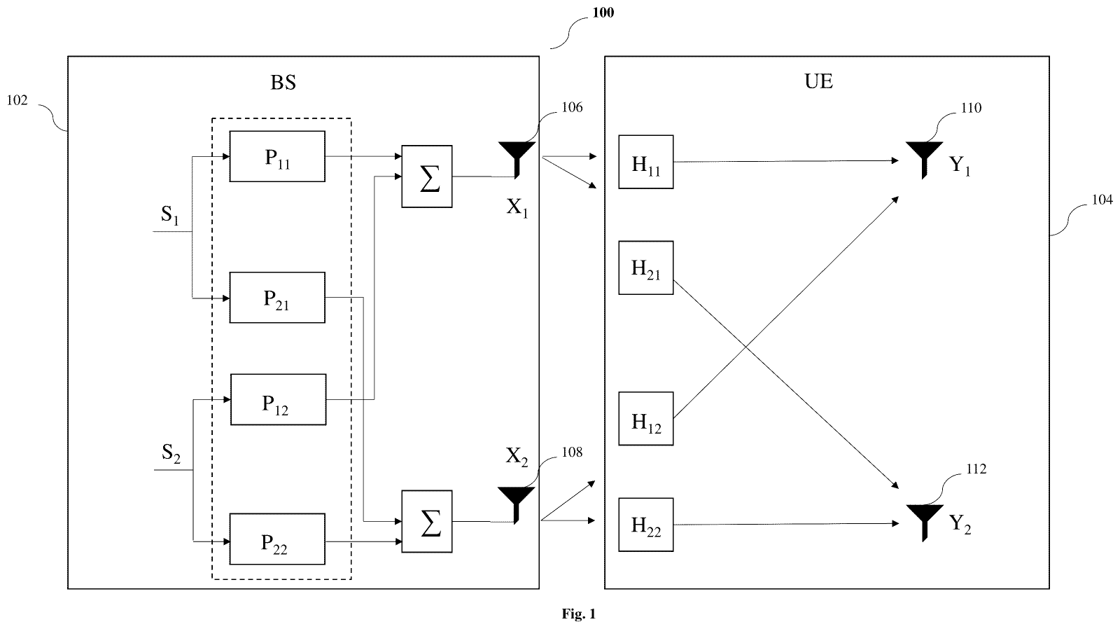

FIG. 1 illustrates a general representation of the precoding process in a 2×2 MIMO system 100. As shown in FIG. 1, S1 and S2 represent two independent streams of signals or data that the transmitter transmits simultaneously. Prior to the transmission, the signals are fed into the precoding block. The precoder is a matrix of weights (P11, P21, P12, P22) that are applied to the data. Further to precoding and Orthogonal Frequency Division Multiplexing (OFDM) processing, the two new, combined signals, X1 and X2, are transmitted from the two transmit antennas.

The signals travel through the wireless channel. FIG. 1 represents these paths with the coefficients h11, h12, h21, and h22. The term h_ij represents the path from transmit antenna j to receive antenna i. The received signals Y1 and Y2 can be represented in a precoder matrix as

$$[ \begin{matrix}Y 1 \\ Y 2\end{matrix} ] = [ \begin{matrix}h 11 & h 12 \\ h 21 & h 22\end{matrix} ] [ \begin{matrix}p 11 & p 12 \\ p 21 & p 22\end{matrix} ] [ \begin{matrix}S 1 \\ S 2\end{matrix} ] .$$

The matrix representation illustrates that the precoding matrix can be multiplied by the channel coefficient matrix (channel matrix and the precoder matrix) to generate a composite channel matrix. This means that, the precoding wrights can be adjusted to help maximize the orthogonality of the coefficients within the coefficients within the composite matrix. The Precoder matrix adjusts the phase and amplitude of the signals from each transmit antenna (X1 and X2) so that they all arrive at the receiver's antennas 110, 112 (Y1 and Y2) in-phase. Thus, selection of correct precoders helps in achieving higher data rates, greater reliability, increased network capacity and thereby improves the performance of MIMO systems.

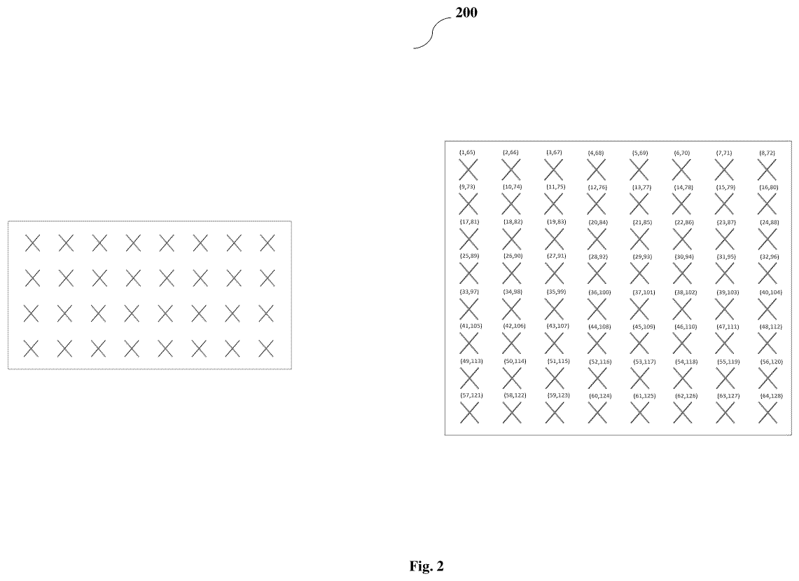

Assuming an antenna panel of dimension (N1, N2), where N1 denotes the number of antenna ports in the first (vertical) dimension and N2 denotes the number of antenna ports in the second (horizontal) dimension. An example of antenna panel 200 of dimension (4,8) is shown in FIG. 2. Each antenna port is associated with a unique integer (α) as an index, where α∈{0,1, . . . , 2N1N2−1}. The antenna ports are indexed sequentially first in N2 dimension and then in N1 dimension for the first polarization in this report, and it is similar for second polarization as well. An antenna panel of dimensions (8,8) is also shown in FIG. 2, where each antenna port is indexed with a unique integer.

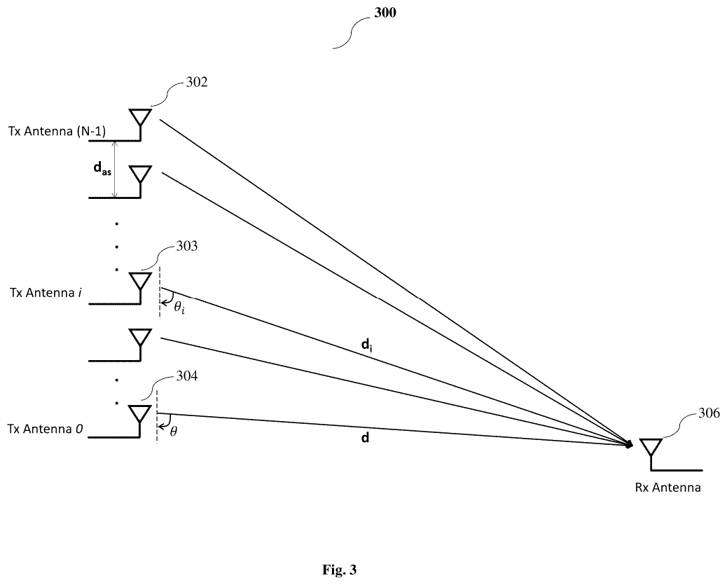

FIG. 3 represents a line of sight (LoS) channel 300 between a transmitter and a receiver in a wireless communication system. As shown in the FIG. 3, the transmitter 302, 303, 304 comprises of N uniformly spaced Transmit (Tx) antenna with an antenna spacing of dₐₛ and a receiver with one Receive (Rx) antenna 306. The phase characteristics of a LoS path is analyzed in this setup. As shown in FIG. 3, all the Tx antennas are indexed with an integer between 0 to N−1. If the angle of departure (AoD) of the LoS path Tx antenna 0 is given as θ and the distance of the LoS path between Rx antenna and Tx antenna 0 is given as d₀, then the distance of the LoS path between Rx antenna and Tx antenna with index i is given as

$${d}_{i} = {( {d}_{0}^{2} + {( i {d}_{a s} )}^{2} + 2 i {d}_{0} {d}_{a s} cos ( θ ) )}^{\frac{1}{2}} \qquad ( 1 )$$

If the distance of the receiver is significantly larger than the size of the antenna panel i.e., d₀>>Ndₐₛ, then (1) can be approximated by using first order Taylor series expansion as

$${d}_{i} = {d}_{0} + i {d}_{a s} cos ( θ ) \qquad ( 2 )$$

However, if the distance of the receiver is not significantly larger than the size of the antenna panel i.e., d₀≈Ndₐₛ, then (2) can be approximated by using second order Taylor series expansion as

$${d}_{i} = ( {d}_{0} + i {d}_{a s} c o s θ + \frac{1}{2 {d}_{0}} {( i {d}_{a s} sin θ )}^{2} ) \qquad ( 3 )$$

If a signal x(t) is transmitted from a Tx antenna i, then the signal received via the LoS path is given as αx(t-τ), where α is the attenuation of the path and τ is the propagation delay. Hence, the time-domain channel due to the LoS path is given as

$$h ( t ) = a δ ( t - τ ) \qquad ( 4 )$$

and the frequency-domain channel due to the LoS path is given as

$$H ( f ) = a {e}^{j 2 π f τ} \qquad ( 5 )$$

The propagation delay of the LoS path depends on the distance traversed by the path d and is given as

$$τ = \frac{d}{c} \qquad ( 6 )$$

Hence, the channel can be rewritten as

$$H ( f ) = {ae}^{\frac{j 2 π fd}{c}} \qquad ( 7 )$$

In the communication system shown in FIG. 3, the channel between the Tx antenna i and Receiver is given as

$${H}_{i} ( f ) = {ae}^{\frac{j 2 π {fd}_{i}}{c}} = {H}_{i} \qquad ( 8 )$$

Where dᵢ is the distance between the Tx antenna i and the receiver

The channel between the transmitter and the receiver is represented as the matrix below

$$H = [ \begin{matrix}{H}_{0} & {H}_{1} & … & {H}_{N - 1}\end{matrix} ] = [ \begin{matrix}{ae}^{\frac{j 2 π {fd}_{0}}{c}} & {ae}^{\frac{j 2 π {fd}_{1}}{c}} & … & {ae}^{\frac{j 2 π f {d}_{N - 1}}{c}} ]\end{matrix} \qquad ( 9 )$$

By substituting dᵢ as per (2), the channel matrix H is rewritten as

$$H = {ae}^{\frac{j 2 π {fd}_{0}}{c}} [ \begin{matrix}1 & {e}^{\frac{j 2 π {fd}_{as} cos ( θ )}{c}} & … & {e}^{\frac{j 2 π f ( N - 1 ) {d}_{as} cos ( θ )}{c}}\end{matrix} ] \qquad ( 10 )$$

From equation (10), it can be seen that the phase of the channel varies linearly across the Tx antennas in the far-field i.e., d₀>>Ndₐₛ. This property is exploited in NR for designing optimal precoder matrices. In NR, DFT-based vectors are used as the basis vectors of a precoder matrix, and the linear phase variation property of a DFT-based vector nullifies the linear phase variation in the channel across Tx antennas.

DFT-based vectors are used as building blocks for constructing a precoder. DFT-based vectors are defined as follows:

$${u}_{m} = \{ \begin{matrix}[ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}} ]}\end{matrix} & {N}_{2} > 1 \\ 1 & {N}_{2} = 1\end{matrix} \} \qquad ( 11 )$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m}\end{matrix} ]}^{T} \qquad ( 12 )$$

$${\tilde{v}}_{l , m} = {[ \begin{matrix}{u}_{m} & {e}^{j \frac{4 π l}{{O}_{1} {N}_{1}}} {u}_{m} & … & {e}^{j \frac{4 π l ( {N}_{1} / 2 - 1 )}{{O}_{1} {N}_{1}}} {u}_{m}\end{matrix} ]}^{T} \qquad ( 13 )$$

Where, N₁, N₂ and O₁, O₂ defines the dimensions of the antenna panel and the oversampling factors respectively and are configured to the UE by the BS.

There are various types of precoder designs or codebooks defined in NR that use DFT-based vectors as basis vectors or Spatial Domain (SD) basis viz., Type-1 Single-Panel Codebook, Type-1 Multi-panel Codebook, Type-2 Codebook, Enhanced Type-2 Codebook, Enhanced Type-2 Codebook for CJT, Enhanced Type-2 Codebook for Predicted PMI. The definitions of each of the aforementioned codebooks is defined in “3GPP TS 38.214” document. For example, the definition of Type-2 Codebook is shown in Table 1 below.

TABLE 1

| Layers | |
|---|---|
| υ = 1 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{( 1 )} = {W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1}$ |
| υ = 2 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , t}^{( 2 )} = \frac{1}{\sqrt{2}} [ {W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} {W}_{{q}_{1} , {q}_{2} , {n}_{1} , {n}_{2} , {n}_{3 , 2} , {p}_{2}^{( 1 )} , {p}_{2}^{( 2 )} , {i}_{2 , 5 , 2} , t}^{2} ]$ |
| υ = 3 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , t}^{( 3 )} = \frac{1}{\sqrt{3}} [ {W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} {W}_{{q}_{1} , {q}_{2} , {n}_{1} , {n}_{2} , {n}_{3 , 2} , {p}_{2}^{( 1 )} , {p}_{2}^{( 2 )} , {i}_{2 , 5 , 2} , t}^{2} {W}_{{q}_{2} , {q}_{2} , {n}_{1} , {n}_{2} , {n}_{3 , 3} , {p}_{3}^{( 1 )} , {p}_{3}^{( 2 )} , {i}_{2 , 5 , 3} , t}^{3} ]$ |
| υ = 4 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , {n}_{3 , 4} , {p}_{4}^{( 1 )} , {p}_{4}^{( 2 )} , {i}_{2 , 5 , 4} , t}^{( 4 )} = \frac{1}{2} [ {W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} {W}_{{q}_{1} , {q}_{2} , {n}_{1} , {n}_{2} , {n}_{3 , 2} , {p}_{2}^{( 1 )} , {p}_{2}^{( 2 )} , {i}_{2 , 5 , 2} , t}^{2} {W}_{{q}_{1} , {q}_{3} , {n}_{1} , {n}_{2} , {n}_{3 , 3} , {p}_{3}^{( 1 )} , {p}_{3}^{( 2 )} , {i}_{2 , 5 , 3} , t}^{3} {W}_{{q}_{1} , {q}_{2} , {n}_{1} , {n}_{3} , {n}_{3 , 4} , {p}_{4}^{( 1 )} , {p}_{4}^{( 2 )} , {i}_{2 , 5 , 4} , t}^{4} ]$ |

$Where {W}_{{q}_{1} , {q}_{2} , {n}_{1} , {n}_{3} , {n}_{3 , l} , {p}_{l}^{( 1 )} , {p}_{l}^{( 2 )} , {i}_{2 , 5 , l} , t}^{l} = \frac{1}{\sqrt{{N}_{1} {N}_{2} {γ}_{t , l}}} [ \begin{matrix}{\sum }_{i = 0}^{L - 1} {v}_{{m}_{1}^{( i )} , {m}_{2}^{( i )}} {p}_{l , 0}^{( 1 )} {\sum }_{f = 0}^{{M}_{υ} - 1} {y}_{t , l}^{( f )} {p}_{l , i , f}^{( 2 )} {φ}_{l , i , f} \\ {\sum }_{i = 0}^{L - 1} {v}_{{m}_{1}^{( t )} , {m}_{2}^{( i )}} {p}_{l , 1}^{( 1 )} {\sum }_{f = 0}^{{M}_{υ} - 1} {y}_{t , l}^{( f )} {p}_{l , i + L , f}^{( 2 )} {φ}_{l , i + L , f}\end{matrix} ] , l = 1 , 2 , 3 , 4 ,$
${γ}_{t , l} = {\sum }_{i = 0}^{2 L - 1} {( {p}_{l , ⌊ \frac{i}{L} ⌋}^{( 1 )} )}^{2} {\vert {\sum }_{f = 0}^{{M}_{υ} - 1} {y}_{t , l}^{( f )} {p}_{l , i , f}^{( 2 )} {φ}_{l , i , f} \vert}^{2}$
$and the mappings from {i}_{1} to {q}_{1} , {q}_{2} , {n}_{1} , {n}_{2} , {n}_{3 , 1} , {n}_{3 , 2} , {n}_{3 , 3} , {n}_{3 , 4} , and from {i}_{2} to {i}_{2 , 5 , 1} , {i}_{2 , 5 , 2} , {i}_{2 , 5 , 3} , {i}_{2 , 5 , 4} , {p}_{1}^{( 1 )} , {p}_{2}^{( 1 )} , {p}_{3}^{( 1 )} and {p}_{4}^{( 1 )} ,$
${p}_{1}^{( 2 )} , {p}_{2}^{( 2 )} , {p}_{3}^{( 2 )} and {p}_{4}^{( 2 )} are as described above , including the ranges of the constituent indices of {i}_{1} and {i}_{2} .$

In this disclosure, all the codebook designs defined in the “3GPP TS 38.214” document are extended by substituting DFT-based SD basis vectors with new SD basis vectors. In the forthcoming paragraphs, the design on the new SD basis (pre-coder information) vectors is elaborated.

The phase variation of a channel across Tx antennas when the UE is in the near-field region are described i.e., d₀≈Ndₐₛ as per FIG. 2.1.1. As per equation (9), the channel matrix is represented as

$$H = [ \begin{matrix}{ae}^{\frac{j 2 π {fd}_{0}}{c}} & {ae}^{\frac{j 2 π {fd}_{1}}{c}} & … & {ae}^{\frac{j 2 π f {d}_{N - 1}}{c}}\end{matrix} ] = {ae}^{\frac{j 2 π {fd}_{0}}{c}} [ \text{} \begin{matrix}1 & {e}^{\frac{j 2 π {fd}_{as} cos ( θ )}{c}} \times {e}^{\frac{j 2 π f ( \frac{1}{2 {d}_{0}} {( {d}_{as} sin θ )}^{2} )}{c}} & … & {e}^{\frac{j 2 π f ( N - 1 ) {d}_{as} cos ( θ )}{c}} \times {e}^{\frac{j 2 π f ( \frac{1}{2 {d}_{0}} {( ( N - 1 ) {d}_{as} sin θ )}^{2} )}{c}}\end{matrix} ] \qquad ( 14 )$$

It can be observed from channel matrix described in equation (14) that the phase variation across Tx antennas is not linear in nature. Hence, the existing precoder designs are no longer optimal in this scenario. Thus, there is a need for novel codebook designs that utilize the non-linear phase variation of the channel to enhance the signal strength at the receiver.

In an embodiment, the precoder for a given channel is constructed based on a set of basis vectors that are preconfigured to the UE by the BS. One or more basis vectors can be used to determine the precoder. A precoder of rank v is given by:

$$P = \frac{1}{√ v ( 2 {N}_{1} {N}_{2} )} [ \begin{matrix}{P}_{0} & {P}_{1} & … & {P}_{v - 1}\end{matrix} ] \qquad ( 15 )$$

Where Pᵢ denotes the precoder corresponding to layer i, where i∈{0,1, . . . , v−1}.

The techniques described throughout this disclosure for constructing precoders for near-field propagation enhance the signal transmission. The methods described herein present a comprehensive approach to design precoders for a given layer in the near-field propagation and hence utilizes the entire panel to transmit any given layer.

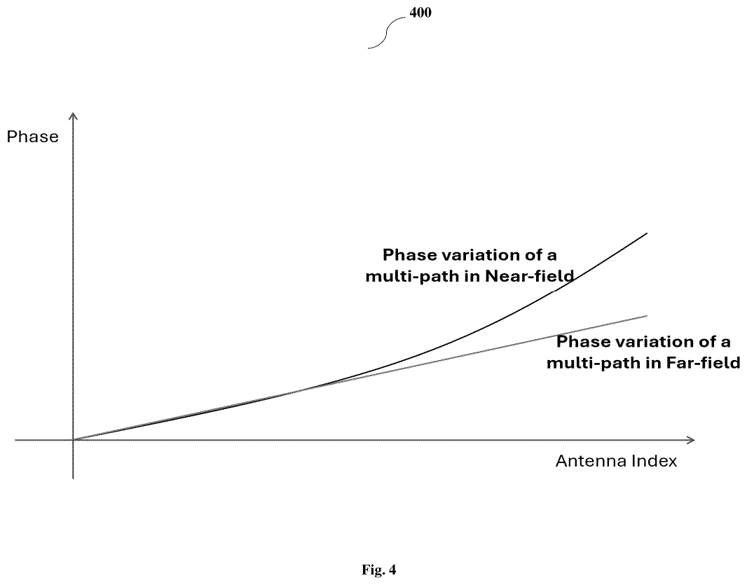

FIG. 4 is a graphical representation 400 of linear and non-linear phase variation in a multi path channel for a UE in near field and far field across the elements of an antenna array in accordance with the embodiments of the present disclosure. FIG. 4 illustrates a fundamental difference between how radio waves behave in the far-field versus the near-field, from the perspective of a large antenna array. The X-axis represents the antenna index, representing the physical position of each antenna element along the array and the Y-axis represents the phase of the radio signal at each specific antenna element.

A conventional precoder is designed to generate the linear phase profile (marked as a straight line). However, if a user is in the near-field, the actual channel behaves according to the curved line, meaning that the phase variation is non-linear. Thus, selecting a linear precoder for a non-linear channel results in a phase mismatch. The signals from all the antenna elements will no longer be received perfectly at the receiver. This distorts the beam, causing a significant loss of signal strength and poor performance. The precoder determination methods as will be discussed in this disclosure are designed to compute and generate precoders that are applicable for the non-linear phase variation, to accurately focus the energy or the beam on a user in the near-field.

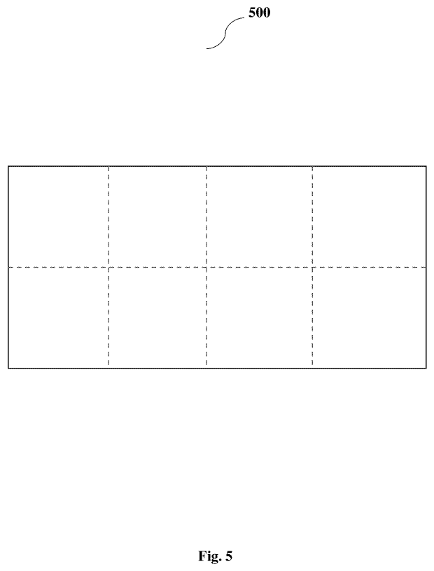

FIG. 5 illustrates a spatial domain basis compression 500 for sub-panel based precoder design in accordance with an embodiment of the present disclosure. The techniques described in FIG. 5 enable efficient beamforming for very large antenna arrays. Due to the origination of the spherical wave front from a single user device, the optimal spatial domain (SD) bases for the different sub-panels are not independent but are, in fact, highly correlated. This inter-sub-panel correlation compresses the feedback information. The technique described herein describes techniques for compressing the representation of the collective SD basis across all sub-panels by parameterizing this spatial correlation in order to effectively reduce the required feedback overhead.

Table 2 illustrates an example where each sub-panel is treated as a completely separate entity. The UE determines the best precoder or beam for each sub-panel individually and then reports the full, complete information for every single sub-panel. Sub-panel A gets its own 4-bit value, Sub-panel B gets its own 4-bit value, Sub-panel E gets its own 2-bit value, and so on. There is no relationship between the information reported for Sub-panel A and Sub-panel B as they are entirely independent. This technique has very high feedback overhead and transmitting the full information for every sub-panel consumes a lot of valuable uplink data capacity.

TABLE 2

| | | | |
|---|---|---|---|
| A | B | C | D |
| 4 (4 Bits) | 4 (2 Bits) | 5 (2 Bits) | 5 (2 Bits) |
| E | F | G | H |
| 5 (2 Bits) | 5 (2 Bits) | 6 (2 Bits) | 6 (2 Bits) |

In an embodiment of the present disclosure, a method for SD basis compression is implemented using an offset-based signalling scheme is disclosed. A reference sub-panel is first designated from among the plurality of sub-panels. The receiver determines a complete description of the optimal SD basis for this reference sub-panel and transmits this reference basis information back to the transmitter. For each of the remaining non-reference sub-panels, the receiver calculates only a differential offset. This offset represents the deviation of the optimal basis for that sub-panel relative to the reference basis. The feedback signal is then composed of the single reference basis and a plurality of these compact offsets. Since the correlation is high, the offsets can be represented with significantly fewer bits than a full basis description, leading to a substantial reduction in total feedback payload.

An example implementation of the offset based signalling scheme is disclosed in table 3 below, where the UE selects one sub-panel, in this case Sub-panel A, as the anchor or reference. It then reports the full, high-precision precoder information for this sub-panel. As shown in table 3, it requires a full 4 bits to report the value ‘4’.

TABLE 3

| | | | |
|---|---|---|---|
| A | B | C | D |
| 4 (4 Bits) | 0 (2 Bits) | 1 (2 Bits) | 1 (2 Bits) |
| E | F | G | H |
| 1 (2 Bits) | 1 (2 Bits) | 2 (2 Bits) | 2 (2 Bits) |

In an embodiment, for all the other sub-panels, the UE will not send the full information. Instead, it sends a smaller value, called the offset that represents the difference from the reference sub-panel. As the differences are usually small, they can be signalled with comparatively fewer bits. Sub-panel B: The report is ‘0’ using only 2 bits. The actual precoder value is Reference (4)+Offset (0)=4. Sub-panel C: The report is ‘1’ using only 2 bits. The actual precoder value is Reference (4)+Offset (1)=5. Sub-panel G: The report is ‘2’ using only 2 bits. The actual precoder value is Reference (4)+Offset (2)=6. Thus, as the number of bits used are less than the individual signalling, there is a significant reduction in feedback overhead, which saves valuable uplink resources.

In another embodiment, a pattern-based signalling scheme is utilized for further compression. This method involves a pre-defined codebook comprising a plurality of spatial patterns, wherein each pattern describes a specific mode of variation of the SD basis across the entire array of sub-panels. For instance, a pattern may define a linear, quadratic, or other functional variation of beam parameters corresponding to the geometric arrangement of the sub-panels. The receiver evaluates the channel and identifies the single pattern from the codebook that best approximates the observed spatial channel characteristics across the array. The feedback message then consists primarily of an index pointing to this selected pattern. This approach provides a higher level of compression, as a single index can effectively communicate the precoding configuration for all sub-panels simultaneously, enabling highly efficient and scalable operation of precoding in near-field, large-scale antenna systems.

An example of the pattern-based signalling is shown in table 4 below. Instead of reporting an offset for every single sub-panel, the UE identifies a recurring pattern and reports a single, short index that describes the entire pattern. First, a reference value is reported for a starting sub-panel (this is the value ‘4’ for the first sub-panel, which requires 4 bits). Next, the UE analyzes the optimal offsets for all the other sub-panels and recognizes a repeating structure (0, 1, 1 in the first row and 1, 1, 2 and 2 in the second row of table 4. The UE selects an index from a predefined “pattern codebook” that both the UE and the base station share. The UE transmits only the short pattern index to communicate this entire complex structure. The advantage of pattern-based signalling is its exceptional compression, leading to a significant reduction in feedback overhead, especially for very large antenna arrays where the precoder settings are often highly correlated and follow predictable patterns.

TABLE 4

| | | | |
|---|---|---|---|
| 4 (4 Bits) | 0 | 1 | 1 |
| 1 | 1 | 2 | 2 |

In an embodiment, the beam is split into linear and non-linear parts with a fixed, predictable pattern for applying the near-field correction across sub-panels. The desired near-field beam into two fundamental components: the far-field component, a standard DFT vector (u_m), the linear part and the near field component (u′_s), the non-linear part.

To achieve compression, the non-linear components for a plurality of sub-panels are not signalled independently, but are instead derived from a single reference sub-panel based on a predetermined rule. In accordance with an embodiment of the present disclosure, the phase of the non-linear component is doubled for each subsequent sub-panel in the array (e.g., u′s, u′_{2s}, u′_{4s}, and so on). This systematic progression of phase shifts across the sub-panels generates a quadratic phase profile over the entire antenna panel, thereby forming the spherical wave front required for precise energy focusing at a specific distance in the near-field. Thus, a complex, full-panel near-field precoder can be communicated with a highly compressed feedback report, comprising, for example, only the indices for the linear component, the reference non-linear component, and the chosen sub-panel size.

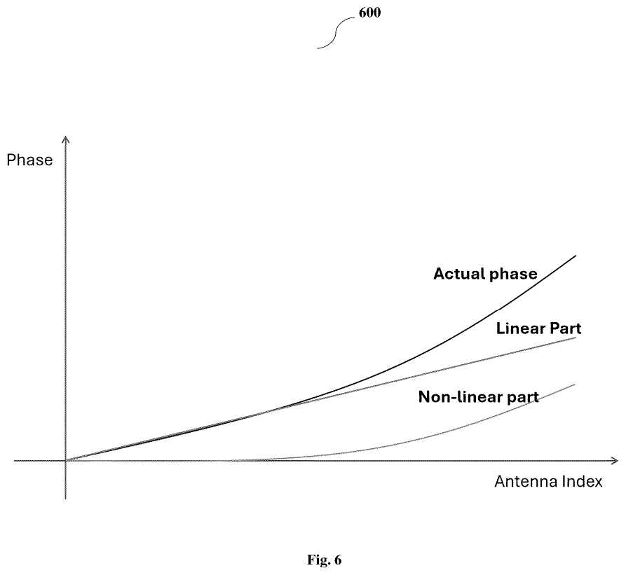

FIG. 6 illustrates an actual phase variation 600 of a multi-path with respect to antenna index in accordance with an embodiment of the present disclosure. SD basis is reported in two parts. The UE thus reports the SD Basis (the precoder information) in two distinct parts. The UE first determines the best linear approximation (the straight line) for the entire antenna pane. This represents the main direction of the beam, or the far-field component. Because this is a simple, straight line, it can be described with “low granularity DFT vectors,” meaning it requires fewer bits to report. Next, the UE calculates the non-linear correction (the line marked as “non-linear part”) needed for the beam to be in correct shape. This correction is complex and varies across the antenna, so it is determined and reported individually for each sub-panel. As this correction involves fine details, it requires “high granularity DFT vectors” for a precise description. Thus, by splitting the report into a simple, full-panel “linear part” and a detailed, per-sub-panel “non-linear part,” the UE can communicate a highly accurate and complex near-field precoder with much greater efficiency than reporting a single, high-granularity vector for the entire panel.

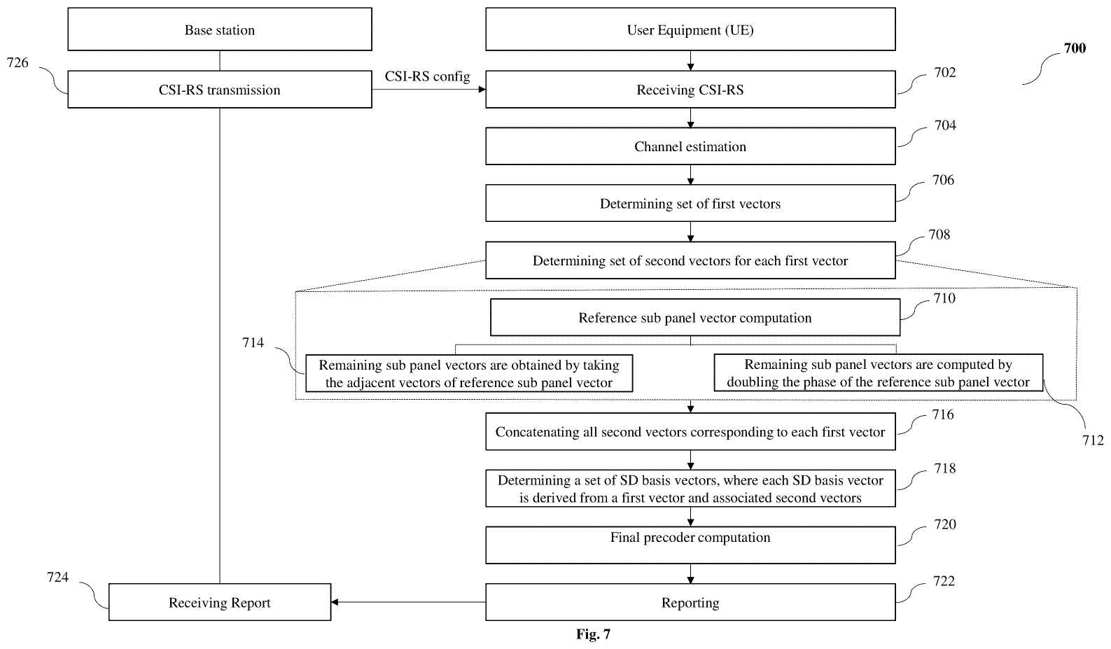

FIG. 7 illustrates a method 700 for designing precoder in a near field according to an embodiment of the present disclosure. The methods disclosed in FIG. 7 primarily focus on different strategies for optimizing precoding in near-field scenarios. In the near field, the each multipath of the channel exhibits a nonlinear phase variation as shown in equation (14). The phase variation of each multipath in the near field follows a quadratic expression in a given antenna panel dimension (horizontal or vertical). In this method, this property of the channel is explored to effectively determine the precoder by a UE.

The antenna panel is divided into sub-panels of equal or unequal sizes as previously shown in FIG. 5. In this method, the UE identifies the SD basis for a reference sub-panel and the SD basis for all other sub-panels are derived based on the SD basis of the reference sub-panel. As shown in equation (14), a channel of a near field UE in a given dimension comprises of two parts viz., a linear part and a non-linear part. The linear part of the phase variation remains constant across all sub-panels and can be nullified by a single DFT-based vector across all the sub-panels. The non-linear part of the phase variation is caused because of a second order term in the phase component. Due to this non-linear phase variation, the strongest DFT vector per sub-panel varies across sub-panels. Consider the DFT vector shown below:

$$v = [ \begin{matrix}1 & {e}^{j ϕ} & … & {e}^{j ( N - 1 ) ϕ}\end{matrix} ] \qquad ( 16 )$$

This vector is represented by an angle φ as the phase of each element in this vector varies by an angle of φ. As per this method, because of the presence of a second order term in the phase variation of the channel in a given dimension, the angle of the best DFT vector per sub-panel doubles with the sub-panel index. For example, in a given dimension, if θ_{L} defines the linear part of the phase variation and θ_{NL} defines the non-linear part of the phase variation, then the strongest DFT-based vector for a given sub-panel i is given as (θ_{L}+2ⁱθ_{NL}).

In this method, the precoder corresponding to layer i, Pᵢ is determined by using one or more basis vectors \tilde{v}_{l,m,t,s}, where \tilde{v}_{l,m,t,s} is defined as a Kronecker product of two vectors ũ_{m,s} and \tilde{v}_{l,t}, i.e.,

$${\tilde{v}}_{l , m , t , s} = {\tilde{v}}_{l , t} ⊗ {\tilde{u}}_{m , s} \qquad ( 17 )$$

Where ũ_{m,s} is obtained as

$${\tilde{u}}_{m , s} = diag ( [ ones ( {N}_{2}^{′} , 1 ) {u}_{s}^{′} … {u}_{mod ( {2}^{i} s , {N}_{2}^{′} {O}_{2}^{′} )}^{′} … {u}_{mod ( {2}^{{N}_{2}^{SP} - {1}_{s , {N}_{2}^{′} {O}_{2}^{′}}} )}^{′} ] ) \times {u}_{m} \qquad ( 18 )$$

And \tilde{v}_{l,t} is obtained as

$${\tilde{v}}_{l , t} = diag ( [ ones ( {N}_{1}^{′} , 1 ) {v}_{t}^{′} … {v}_{mod ( {2}^{j} t , {N}_{2}^{′} {O}_{2}^{′} )}^{′} … {v}_{mod ( {2}^{{N}_{2}^{SP} - {1}_{t , {N}_{1}^{′} {O}_{1}^{′}}} )}^{′} ] ) \times {v}_{l} \qquad ( 19 )$$

uₘ and vₗ capture the linear part of the channel, úₛ and \acute{v}ₜ capture the non-linear part of the channel.

diag( ) is defined as a function such that for any given vector x̅, diag(x̅) is a diagonal matrix with the elements of x̅ as the diagonal elements. And ones(x, 1) is defined as a row vector of size x such that the value of all elements in the vector is 1.

In an embodiment, uₘ and vₗ are the oversampled DFT vectors of size N₂ and N₁ respectively where uₘ is oversampled by a factor of O₂ and vₗ is oversampled by a factor of O₁. uₘ and vₗ are represented as follows

$${u}_{m} = [ \begin{matrix}1 & {e}^{j \frac{2 π m}{{N}_{2} {O}_{2}}} & … & {{e}^{j \frac{2 π m ( {N}_{2} - 1 )}{{N}_{2} {O}_{2}}} ]}^{T}\end{matrix} \qquad ( 20 )$$

$${v}_{l} = [ \begin{matrix}1 & {e}^{j \frac{2 π l}{{N}_{1} {O}_{1}}} & … & {e}^{{j \frac{2 π l ( {N}_{1} - 1 )}{{N}_{1} {O}_{1}} ]}^{T}}\end{matrix} \qquad ( 21 )$$

Where m∈{0,1, . . . , N₂O₂−1} and l∈{0,1, . . . , N₁O₁−1}

In an embodiment, úₛ and \acute{v}ₜ are also oversampled DFT vectors. The size of úₛ and \acute{v}ₜ depends on the size of the sub-panel in N₂ dimension and N₁ dimension respectively. The values of

$${N}_{2}^{SP} and {N}_{1}^{SP}$$

in (18) and (19) define the number of sub-panels in N₂ dimension and N₁ dimension, respectively. If the sub-panel size in N₁ dimension is

$${N}_{1}^{′} ,$$

then the number of sub-panels in the N₁ dimension,

$${N}_{1}^{SP} ,$$

is derived as

$${N}_{1}^{SP} = ⌈ \frac{{N}_{1}}{{N}_{1}^{′}} ⌉ \qquad ( 22 )$$

In an embodiment, if the sub-panel size in N₂ dimension is

$${N}_{2}^{′} ,$$

then the number of sub-panels in N₂ dimension,

$${N}_{2}^{SP} ,$$

is derived as

$${N}_{2}^{SP} = ⌈ \frac{{N}_{2}}{{N}_{2}^{′}} ⌉ \qquad ( 23 )$$

Hence, in equations (18) and (19),

$$i ∈ \{ 1 , 2 , … , {N}_{2}^{SP} - 1 \} and j ∈ \{ 1 , 2 , … , {N}_{1}^{SP} - 1 \} .$$

For example, if the sub-panel size in N₂ dimension is equal to N₂ i.e., there is only one sub-panel in N₂ dimension, then as per (18), ũ_{m,s}=uₘ. Similarly, if the sub-panel size in N₂ dimension is equal to N₂/2 i.e., N₂ dimension is divided into two sub-panels, then as per (18),

$${\tilde{u}}_{m , s} = diag ( [ \begin{matrix}ones ( {N}_{2}^{′} , 1 ) & {{u}^{′}}_{s} ] ) \times {u}_{m}\end{matrix}$$

The vectors úₛ and \acute{v}ₜ are derived as

$${{u}^{′}}_{s} = [ \begin{matrix}1 & {e}^{j \frac{2 π s}{{N}_{2}^{′} {O}_{2}^{′}}} & … & {e}^{j \frac{2 π s ( {N}_{2}^{′} - 1 )}{{N}_{2}^{′} {O}_{2}^{′}}} ]\end{matrix} \qquad ( 24 )$$

$${{v}^{′}}_{t} = [ \begin{matrix}1 & {e}^{j \frac{2 π t}{{N}_{1}^{′} {O}_{1}^{′}}} & … & {e}^{j \frac{2 π t ( {N}_{1}^{′} - 1 )}{{N}_{1}^{′} {O}_{1}^{′}}} ]\end{matrix} \qquad ( 25 )$$

Where s∈{0,1, . . . , X} and t∈{0,1, . . . , Y}, where X and Y are configured to the UE by the BS where

$$X ∈ \{ 0 , 1 , … , {N}_{2}^{′} {O}_{2}^{′} - 1 \} and Y ∈ \{ 0 , 1 , … , {N}_{1}^{′} {O}_{1}^{′} - 1 \} .$$

It can be seen from equations (24) and (25) that úₛ and \acute{v}ₜ are DFT vectors of size

$${N}_{2}^{′} and {N}_{1}^{′}$$

respectively and oversampled by

$${O}_{2}^{′} and {O}_{1}^{′}$$

respectively.

All the codebooks specified in “3GPP TS 38.214” document can be extended by substituting v_{l,m} with \tilde{v}_{l,m,t,s} in the precoder equation. For example, The Type-1 precoder structure for single layer is as follows:

$${W}_{l , m , t , s , n}^{( 1 )} = [ \begin{matrix}{\tilde{v}}_{l , m , t , s} \\ {φ}_{n} {\tilde{v}}_{l , m , t , s}\end{matrix} ] \qquad ( 26 )$$

$${φ}_{n} = {e}^{j \frac{π n}{2}}$$

In an embodiment, the BS configures the UE with at least one of the following: The dimension of the antenna panel (N₁, N₂), Oversampling factors (O₁, O₂) corresponding to the linear part of the precoder, Set of sub-panel sizes i.e.,

$${N}_{1}^{′} , {N}_{2}^{′}$$

and oversampling factors for each sub-panel size

$${O}_{1}^{′} , {O}_{2}^{′} ,$$

X and Y, where X and Y represents the number of oversampled DFT vectors that are configured for non-linear part of the precoder and Index of a reference sub-panel.

In an embodiment, the UE reports the BS at least one of the following: Linear SD basis, where SD basis comprises of a set of l and m values, Non-linear SD basis, where Non-linear SD basis comprises of s and t values and Size of the sub-panel among the configured sizes.

The method as disclosed in FIG. 7 begins at step 702, where a Base Station transmits Channel State Information Reference Signals (CSI-RS) to a UE. The transmission may be based on a CSI-RS 726 configuration provided to the UE.

At step 704, the UE receives the CSI-RS and, at step 706, performs a channel estimation to determine the characteristics of the communication channel. Based on the channel estimation, the UE proceeds with a two-stage vector determination process. At step 708, the UE determines a first set of vectors, which may correspond to a coarse, wide-beam selection.

Subsequently, at step 710, the UE determines a second, more granular set of vectors for each of the first vectors. This step, detailed in block 712, begins with a reference sub-panel vector computation. The remaining sub-panel vectors are then computed using one of two alternative methods. In one embodiment at step 714, the remaining sub-panel vectors are obtained by taking the adjacent vectors of the reference sub-panel vector. In another embodiment at step 716, the remaining sub-panel vectors are computed by doubling the phase of the reference sub-panel vector.

At step 718, the UE concatenates all the second vectors corresponding to each first vector. Then, at step 720, the UE uses this information to determine a set of SD (Spatial Domain) basis vectors, where each SD basis vector is derived from a combination of a first vector and its associated second vectors.

At step 722, a final precoder is computed from the set of SD basis vectors. The UE then proceeds to a reporting phase, transmitting a report corresponding to the final precoder to the Base Station. Finally, at step 724, the Base Station receives the report from the UE and may use the indicated precoder for subsequent data transmissions.

Designing the precoder in this method is driven by the non-linear nature of the near-field channel phase. To replicate this effect in the precoder design, the UE computes the precoder in two parts.

In an embodiment, the first part addresses the linear component, which is computed across the entire antenna panel using low granularity, oversampled DFT vectors. For the non-linear component, the antenna panel is divided into sub-panels. In this method, a cluster of DFT vectors are used for constructing a basis vector where a cluster of DFT vectors are defined as a set of contiguous DFT vectors in a given dimension.

In an embodiment, Pᵢ (The precoder corresponding to layer i) is determined by using one or more basis vectors \tilde{v}_{l,m,t,s}, where \tilde{v}_{l,m,t,s} is defined as a Kronecker product of two vectors ũ_{m,s} and \tilde{v}_{l,t}, i.e.,

$${\tilde{v}}_{l , m , t , s} = {\tilde{v}}_{l , t} ⊗ {\tilde{u}}_{m , s} \qquad ( 27 )$$

Where ũ_{m,s} is obtained as

$${\tilde{u}}_{m , s} = diag ( [ \begin{matrix}{{u}^{′}}_{s} & {{u}^{′}}_{m od ( s + 1 , {N}_{2}^{′} {O}_{2}^{′} )} & {{u}^{′}}_{m od ( s + 2 , {N}_{2}^{′} {O}_{2}^{′} )} & {{u}^{′}}_{m od ( s + 3 , {N}_{2}^{′} {O}_{2}^{′} )} & ⋯ & {{u}^{′}}_{m od ( s + {N}_{2}^{SP} - 1 , {N}_{2}^{′} {O}_{2}^{′} )} ] ) \times {u}_{m}\end{matrix} \qquad ( 28 )$$

And \tilde{v}_{l,t} is obtained as

$${\tilde{v}}_{l , t} = diag ( [ \begin{matrix}{{v}^{′}}_{t} & {{v}^{′}}_{m od ( t + 1 , {N}_{1}^{′} {O}_{1}^{′} )} & {{v}^{′}}_{m od ( t + 2 , {N}_{1}^{′} {O}_{1}^{′} )} & {{v}^{′}}_{m od ( t + 3 , {N}_{1}^{′} {O}_{1}^{′} )} & ⋯ & {{v}^{′}}_{mo d ( t + {N}_{1}^{SP} - 1 , {N}_{1}^{′} {O}_{1}^{′} )} ] ) \times {v}_{l}\end{matrix} \qquad ( 29 )$$

In an embodiment, uₘ and vₗ capture the linear part of the channel, úₛ and \acute{v}ₜ capture the non-linear part of the channel. uₘ and vₗ are the oversampled DFT vectors of size N₂ and N₁ respectively where uₘ is oversampled by a factor of O₂ and vₗ is oversampled by a factor of O₁. uₘ and vₗ are represented as follows

$${u}_{m} = {[ \begin{matrix}1 & {e}^{j \frac{2 π m}{{N}_{2} {O}_{2}}} & … & {e}^{j \frac{2 π m ( {N}_{2} - 1 )}{{N}_{2} {O}_{2}}}\end{matrix} ]}^{T} flinear bas \qquad ( 30 )$$

$${v}_{l} = {[ \begin{matrix}1 & {e}^{j \frac{2 π l}{{N}_{1} {O}_{1}}} & … & {e}^{j \frac{2 π l ( {N}_{1} - 1 )}{{N}_{1} {O}_{1}}}\end{matrix} ]}^{T} \qquad ( 31 )$$

Where m∈{0,1, . . . , N₂O₂−1} and l∈{0,1, . . . , N₁O₁−1}

In an embodiment, úₛ and \acute{v}ₜ are highly oversampled DFT vectors. The size of úₛ and \acute{v}ₜ depends on the size of the sub-panel in N₂ dimension and N₁ dimension respectively. If the sub-panel size in N₁ dimension is

$${N}_{1}^{′} ,$$

then the number of sub-panels in the N₁ dimension,

$${N}_{1}^{SP} ,$$

is derived as

$${N}_{1}^{SP} = ⌈ \frac{{N}_{1}}{{N}_{1}^{′}} ⌉ \qquad ( 32 )$$

In an embodiment, if the sub-panel size in N₂ dimension is

$${N}_{2}^{′} ,$$

then the number of sub-panels in N₂ dimension,

$${N}_{2}^{SP} ,$$

is derived as

$${N}_{2}^{SP} = ⌈ \frac{{N}_{2}}{{N}_{2}^{′}} ⌉ \qquad ( 33 )$$

The vectors úₛ and \acute{v}ₜ are derived as

$${{u}^{′}}_{s} = [ \begin{matrix}1 & {e}^{j \frac{2 π s}{{N}_{2}^{′} {O}_{2}^{′}}} & … & {e}^{j \frac{2 π s ( {N}_{2}^{′} - 1 )}{{N}_{2}^{′} {O}_{2}^{′}}}\end{matrix} ] \qquad ( 34 )$$

$${{v}^{′}}_{t} = [ \begin{matrix}1 & {e}^{j \frac{2 π t}{{N}_{1}^{′} {O}_{1}^{′}}} & … & {e}^{j \frac{2 π t ( {N}_{1}^{′} - 1 )}{{N}_{1}^{′} {O}_{1}^{′}}}\end{matrix} ] \qquad ( 35 )$$

Where s∈{0,1, . . . , X} and t∈{0,1, . . . , Y}, where X and Y are configured to the UE by the BS where

$$X ∈ \{ 0 , 1 , … , {N}_{2}^{′} {O}_{2}^{′} - 1 \} and Y ∈ \{ 0 , 1 , … , {N}_{1}^{′} {O}_{1}^{′} - 1 \}$$

It can be seen from (34) and (35) that úₛ and \acute{v}ₜ are DFT vectors of size

$${N}_{2}^{′} and {N}_{1}^{′}$$

respectively and oversampled by

$${O}_{2}^{′} and {O}_{1}^{′}$$

respectively. All the codebooks specified in “3GPP TS 38.214” can be extended by substituting v_{l,m} with \tilde{v}_{l,m,t,s} in the precoder equation. For example, The Type-1 precoder structure for single layer is as follows:

$$\begin{matrix}{W}_{l , m , t , s , n}^{( 1 )} = [ \begin{matrix}{\tilde{v}}_{l , m , t , s} \\ {φ}_{n} {v}_{l , m , t , s}\end{matrix} ] \\ {φ}_{n} = {e}^{j \frac{nn}{2}}\end{matrix} \qquad ( 36 )$$

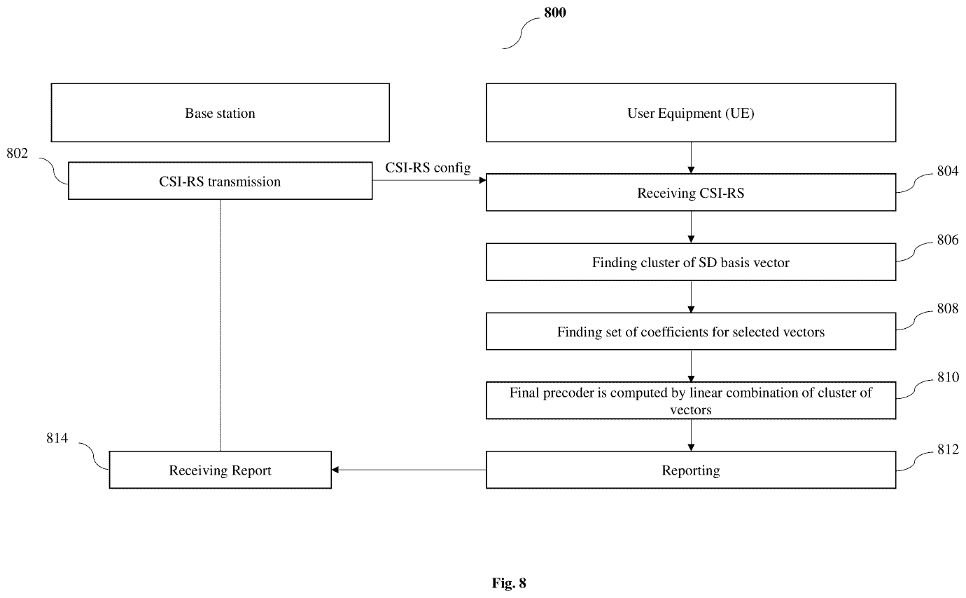

In an embodiment, as per the method disclosed in FIG. 8, the BS configures the UE with at least one of the following: The dimension of the antenna panel (N₁, N₂), Oversampling factors (O₁, O₂) corresponding to the linear part of the precoder, Set of sub-panel sizes i.e.,

$${N}_{1}^{′} , {N}_{2}^{′}$$

and oversampling factors for each sub-panel size

$${O}_{1}^{′} , {O}_{2}^{′}$$

and X and Y, where X and Y represents the number of oversampled DFT vectors that are configured for non-linear part of the precoder.

In an embodiment, the UE reports the BS at least one of the following: Linear SD basis, where SD basis comprises of a set of l and m values, non-linear SD basis, where Non-linear SD basis comprises of s and t values and size of the sub-panel among the configured sizes.

FIG. 8 illustrates a cluster-based method 800 for designing precoder in a near field according to an embodiment of the present disclosure. The method disclosed in FIG. 8 begins at step 802, where a Base Station transmits CSI-RS to a UE, optionally based on a CSI-RS configuration.

At step 804, the UE receives the CSI-RS and performs a channel estimation. Based on this estimation, the UE proceeds to compute a custom precoder. At step 806, instead of selecting a single best precoder, the UE finds a cluster of SD basis vectors. This cluster comprises one or more basis vectors from a codebook that are determined to be most representative of the channel conditions.

Next, at step 808, the UE finds a set of coefficients (or weights) for the vectors selected in the previous step. These coefficients determine the optimal proportion of each basis vector to include in the final precoder. At step 810, the final precoder is computed by forming a linear combination of the vectors in the cluster. Each basis vector is weighted by its corresponding coefficient, and the weighted vectors are summed to create a new, custom precoder vector that is more precisely matched to the channel than any single basis vector from the codebook.

At step 812, the UE performs reporting, generating and transmitting a report to the base station. This report may include indices identifying the selected cluster of basis vectors and the determined set of coefficients. Finally, at step 814, the Base Station receives the report, reconstructs the final precoder based on the indicated information, and may use it for subsequent data transmissions to the UE.

In the near-field, because of the spherical nature of the wave experienced at the receiver, there will be more than one strong DFT vector for any given multi-path. As a result, multiple DFT vectors are required to nullify the phase variation of any given multi-path. In this method, the basis vectors for construction of a precoder is obtained by a linear combination of a set of oversampled DFT vectors in this method. The number of vectors selected used for linear combination depends on the amount of the non-linearity.

The precoder Pᵢ is determined by using one or more basis vectors \tilde{v}_{l,m,t,s}, where \tilde{v}_{l,m,t,s} is defined as a Kronecker product of two vectors v̅_{l,t} and ū_{m,s} i.e.,

$${\tilde{v}}_{l , m , t , s} = {\tilde{v}}_{l , t} ⊗ {\tilde{u}}_{m , s} \qquad ( 37 )$$

\tilde{v}_{l,t} and ũ_{m,s} are obtained from vₗ and uₘ which are oversampled DFT vectors.

$${v}_{l} = {[ \begin{matrix}1 & {e}^{j \frac{2 π l}{{N}_{1} {O}_{1}}} & … & {e}^{j \frac{2 π l ( {N}_{1} - 1 )}{{N}_{1} {O}_{1}}}\end{matrix} ]}^{T} l ∈ \{ 0 , 1 , … , {N}_{1} {O}_{1} - 1 \} \qquad ( 38 )$$

$${u}_{m} = {[ \begin{matrix}1 & {e}^{j \frac{2 π m}{{N}_{2} {O}_{2}}} & … & {e}^{j \frac{2 π m ( {N}_{2} - 1 )}{{N}_{2} {O}_{2}}}\end{matrix} ]}^{T} , m ∈ \{ 0 , 1 , … , {N}_{2} {O}_{2} - 1 \} \qquad ( 39 )$$

(N₁, N₂) are the dimensions of the antenna panel and (O₁, O₂) are the oversampling factors.

In an embodiment, \tilde{v}_{l,t} and ũ_{m,s} is obtained by taking linear combination of (s, t) number of oversampled DFT vectors from vₗ and uₘ. The number of vectors selected for performing linear combination will depend on the amount of non-linearity. The vectors \tilde{v}_{l,t} and ũ_{m,s} are represented as

$${\tilde{u}}_{m , s} = {α}_{0} {u}_{m} + {α}_{1} {u}_{m o d ( m + 1 , {N}_{2} {O}_{2} )} + ⋯ + {α}_{s - 1} {u}_{m o d ( m + s - 1 , {N}_{2} {O}_{2} )} \qquad ( 40 )$$

$${\tilde{v}}_{l , t} = {β}_{0} {v}_{l} + {β}_{1} {v}_{m o d ( l + 1 {N}_{1} {O}_{1} )} + ⋯ + {β}_{t - 1} {v}_{m o d ( l + t - 1 , {N}_{1} {O}_{1} )} \qquad ( 41 )$$

Where α̅=[α₀ α₁ . . . αₛ₋₁] and β̅=[β₀ β₁ . . . βₜ₋₁] are derived from a preconfigured set of coefficients used for performing linear combination.

In an embodiment, all the codebooks specified in “3GPP TS 38.214” can be extended by substituting v_{l,m} with \tilde{v}_{l,m,t,s} in the precoder equation. For example, The Type-1 precoder structure for single layer is as follows:

$${W}_{l , m , t , s , n}^{( 1 )} = [ \begin{matrix}{\tilde{v}}_{l , m , t , s} \\ {φ}_{n} {\tilde{v}}_{l , m , t , s}\end{matrix} ] \qquad ( 42 )$$

$${φ}_{n} = {e}^{j \frac{π n}{2}}$$

As per the method disclosed in FIG. 8, the BS configures the UE with at least one of the following: the dimension of the antenna panel (N₁, N₂), Oversampling factors (O₁, O₂) corresponding to the linear part of the precoder, set of sub-panel sizes i.e.,

$${N}_{1}^{′} , {N}_{2}^{′} ,$$

a set of s and t values and Multiple sets of α̅ and β̅ in accordance with an embodiment of the present disclosure.

An example configuration of s, t, α̅ and β̅ is shown in table 5 below:

TABLE 5

| (s, t) | Coefficients |
|---|---|
| (3, 3) | $[ {α}_{0}^{1} , {α}_{1}^{1} , {α}_{2}^{1} ] , [ {β}_{0}^{1} , {β}_{1}^{1} , {β}_{2}^{1} ]$ |
| | $[ {α}_{0}^{2} , {α}_{1}^{2} , {α}_{2}^{2} ] , [ {β}_{0}^{2} , {β}_{1}^{2} , {β}_{2}^{2} ]$ |
| | $[ {α}_{0}^{3} , {α}_{1}^{3} , {α}_{2}^{3} ] , [ {β}_{0}^{3} , {β}_{1}^{3} , {β}_{2}^{3} ]$ |
| (5, 5) | $[ {α}_{0}^{1} , {α}_{1}^{1} , {α}_{2}^{1} , {α}_{3}^{1} , {α}_{4}^{1} ] , [ {β}_{0}^{1} , {β}_{1}^{1} , {β}_{2}^{1} , {β}_{3}^{1} , {β}_{4}^{1} ]$ |
| | $[ {α}_{0}^{2} , {α}_{1}^{2} , {α}_{2}^{2} , {α}_{3}^{2} , {α}_{4}^{2} ] , [ {β}_{0}^{2} , {β}_{1}^{2} , {β}_{2}^{2} , {β}_{3}^{2} , {β}_{4}^{2} ]$ |
| | $[ {α}_{0}^{3} , {α}_{1}^{3} , {α}_{2}^{3} , {α}_{3}^{3} , {α}_{4}^{3} ] , [ {β}_{0}^{3} , {β}_{1}^{3} , {β}_{2}^{3} , {β}_{3}^{3} , {β}_{4}^{3} ]$ |

In an embodiment, the UE reports the BS at least one of the following: a set of l and m values, where each pair of (l, m) is used for obtaining a basis vector, a cluster size among a preconfigured set of cluster sizes (s, t) and plurality of set of linear combination coefficients where each set is associated with one SD basis vector out of the plurality of SD basis vectors reported.

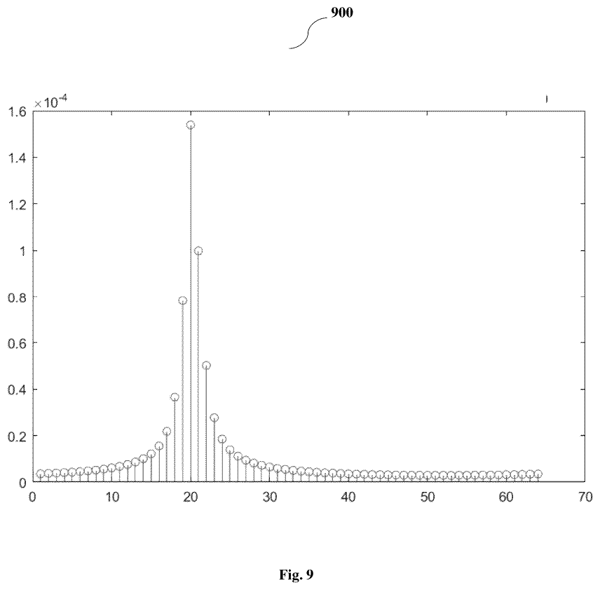

FIG. 9 illustrates a graphical representation 900 of spatial domain basis reported as a cluster of DFT vectors in accordance with an embodiment of the present disclosure. In an embodiment, a cluster-based SD basis is utilized to accurately represent the channel, particularly in scenarios subject to beam spreading. In this method, instead of using a single DFT vector which may only capture the main peak of the channel response, the SD basis is reported as a cluster of multiple DFT vectors.

In an embodiment, this cluster is configured to capture not only the primary channel path but also the energy that has spread to adjacent domains. The final precoder is then computed as a linear combination of the multiple vectors within the reported cluster, using a set of predefined combining coefficients. The size of the cluster can be configured to the UE to adapt to varying degrees of beam spreading, thereby enabling a more accurate channel representation and a more optimal precoder than what is achievable with a single-vector approach.

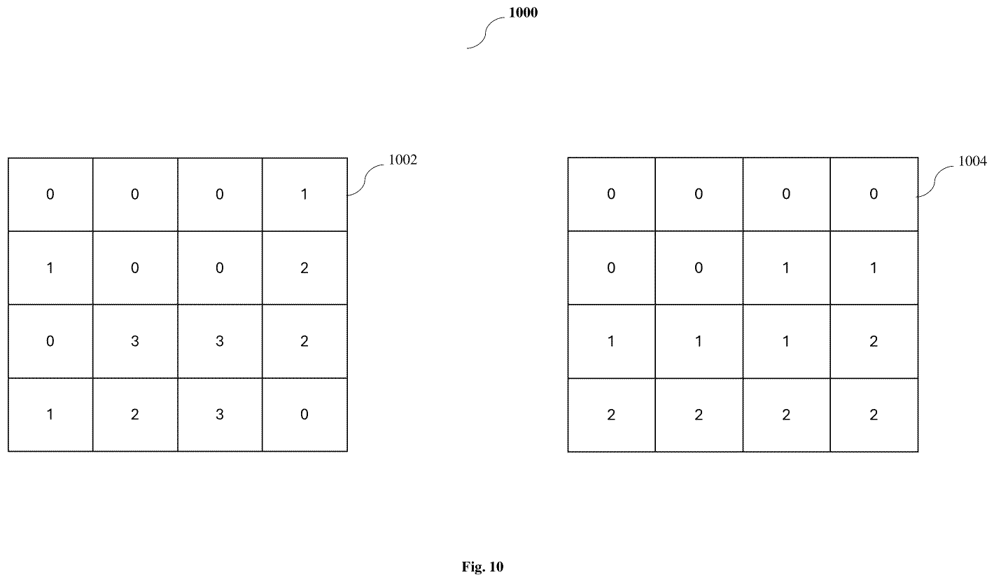

The method disclosed in FIG. 10 discuss different ways 1000 of selecting sub-panels across layers, to avoid limitation of spectral efficiency due to supported CQI rates. This allows spatial multiplexing of layers across sub-panels, where each layer uses a subset of sub-panels available over the entire antenna array. Here the sub-panel refers to a small contiguous portion of antenna elements.

In the near field, the rank of the channel will be lesser than the far-field due to the lesser number of multi-paths Hence, by using traditional methods, higher rank transmissions may not be possible. To address the aforesaid technical problem, the entire antenna panel is divided into multiple sub-panels of equal or unequal size where each sub-panel is associated with a sub-panel index. The association between a sub-panel index and the antenna elements that are associated with the corresponding sub-panel index is configured to the UE by the BS explicitly or implicitly. In the method shown in FIG. 10, the BS does not transmit any given layer by using all the antenna elements or ports but the BS transmits a given layer by using a subset of sub-panels. In this method, each layer of the precoder is associated with multiple sub-panels. The association between a sub-panel and a layer is either determined by the UE based on a metric associated with the sub-panel or preconfigured to the UE by the BS. The metric can be at least one of SD basis of the sub-panel, spectral efficiency (SE) corresponding to a layer etc.

In one example, if the metric is configured as SD basis, then UE determines that two sub-panels transmit the same layer if at least M SD-basis vectors out of the L SD-basis vectors determined for each of the sub-panel are the same for the two sub-panels. For example, if a UE is configured to determine L=4 SD basis vectors per sub-panel and M=3, then the UE determines that two sub-panels transmit a same layer if at least 3 out of the 4 SD basis vectors, determined per sub-panel, are the same between the two sub-panels.

As shown in FIG. 10, the antenna panel is divided into 16 sub-panels i.e., the larger block represents the antenna panel which is divided into multiple smaller blocks where each smaller block represents a sub-panel. In the left part of the FIG. 1002, the SD basis index corresponding to each of the sub-panels is shown and on the right part of the figure, the layer index corresponding to each of the sub-panels is shown. It can be seen that all the sub-panels with a common SD basis vector transmit the same layer. For example, all the sub-panels with i as the SD basis vector transmits layer 0.

In another example, if the metric is configured as SE, then the BS configures a threshold SE value T. The UE determines the precoder per sub-panel and the UE selects a consecutive set of sub-panels for a given layer such that the SE of the layer is higher than the threshold T.

The figure illustrated in the right-hand side 1004 shows a larger block representing a full antenna panel that is divided into multiple smaller blocks, where each small block represents a sub-panel. It is seen that the UE selects a set of consecutive sub-panels until the SE threshold is reached per layer. Once the SE threshold is reached, the UE repeats the same procedure for the next layer and so on.

In another example, the BS preconfigures the layer to sub-panel mapping to the UE for each rank. The UE computes the precoder and CQI for each rank based on the preconfigured mapping and reports the rank information to the BS. Further, the BS transmits a given layer using the sub-panels that are associated with the layer for the reported rank.

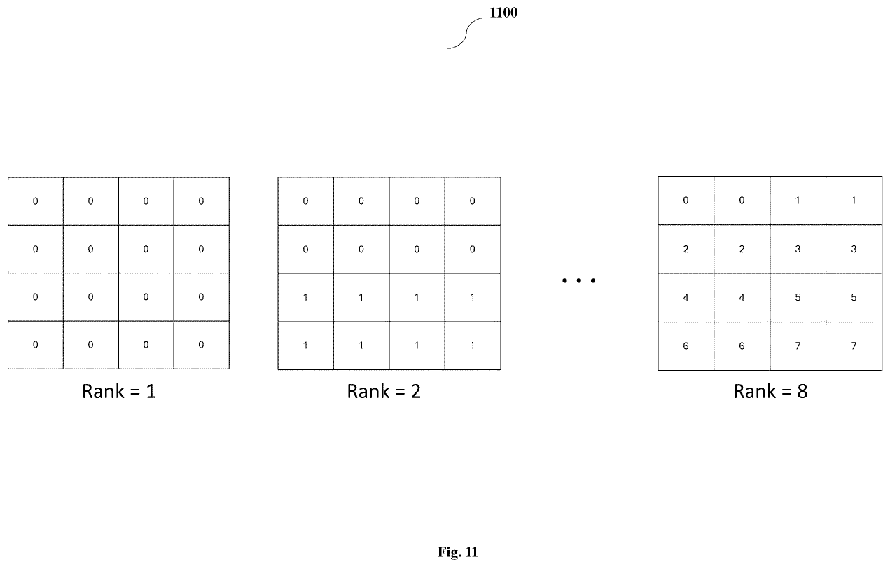

FIG. 11 illustrates a fixed mapping 1100 between a layer index and the sub-panels for any given rank in accordance with an embodiment of the present disclosure. As shown in FIG. 11, the antenna panel is divided into multiple sub-panels. The figure shows a fixed mapping between a layer index and the sub-panels for any given rank. For example, in the figure shown below, layer 0 is associated with all sub-panels for Rank 1. Layer 0 is associated with half of the available set of sub-panels and Layer 1 is associated with other half of the available set of sub-panels for Rank 2.

In this method, the BS configures the UE with at least one of the following: the dimension of the antenna panel (N₁, N₂), dimensions of each sub-panel, number of sub-panels, association between the antenna elements or antenna ports with each of the sub-panel, L, M values and type of metric per sub-panel for determining layer to sub-panel association

In an embodiment, a precoder per sub-panel comprises at least a set of L SD basis vectors. In one example, for a given layer i, UE reports a set of M SD basis vectors out of L are reported commonly i.e., using a common set of parameters, for all the sub-panels associated with layer i and the remaining set of (L-M) SD basis vectors per sub-panel are reported separately i.e., using a different set of parameters i.e. association between a layer index and a sub-panel index, number of sub-panels associated with a layer index and rank index.

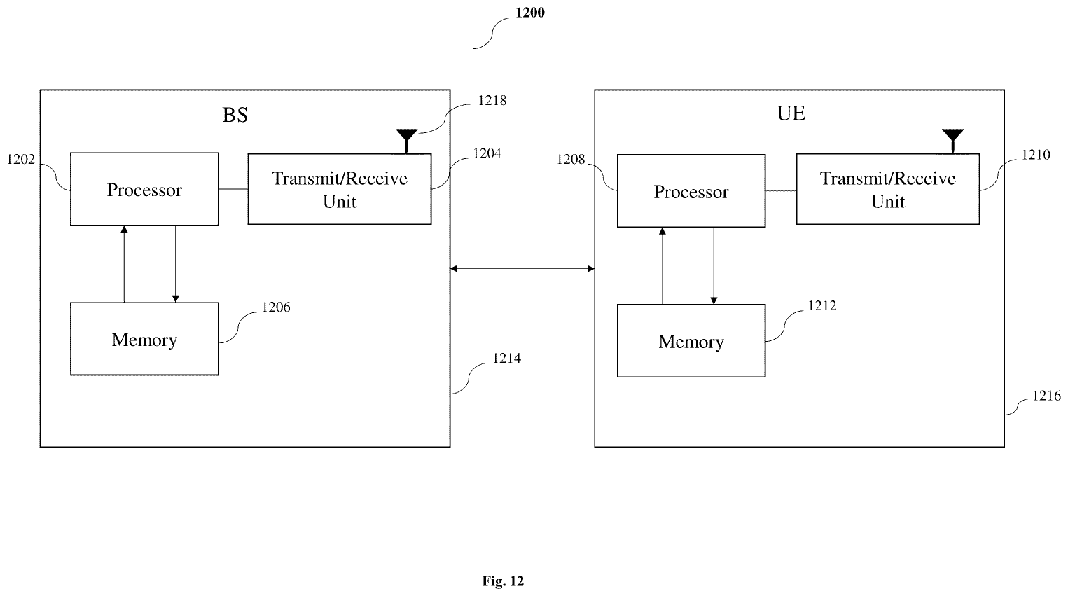

FIG. 12 is an example wireless communication system 1200 configured to perform the methods described in the present disclosure. The BS 1214 comprises a processor 1202, a transmit/receive unit 1204 coupled to one or more antennas, and a memory 1206. The memory 1206 may store instructions that, when executed by the processor 1202, cause the BS 1214 to perform its designated functions. The transmit/receive unit 1204 is configured to transmit downlink signals, such as CSI-RS, and receive uplink signals, such as feedback reports from the UE.

The UE 1216 comprises a processor 1208, a transmit/receive unit 1210 coupled to one or more antennas, and a memory 1212. The memory 1212 may store instructions that, when executed by the processor 1208, cause the UE 1216 to perform all the UE-side steps of the methods described herein.

In various embodiments of the present disclosure, the components of the system 1200 are configured to operate in conjunction to perform the methods for precoder determination and spatial multiplexing. Specifically, the processor 1208 of the UE 1216 is configured to receive CSI-RS via the transmit/receive unit 1210, perform channel estimation, and determine a final precoder by executing any one or a combination of the previously described methods throughout this disclosure. The processor 1208 is further configured to generate a report corresponding to the determined precoder and cause the transmit/receive unit 1210 to transmit said report to the BS 1214. The processor 1202 of the BS 1214 is configured to receive said report via the transmit/receive unit 1204 and use the indicated precoder for subsequent data transmissions.

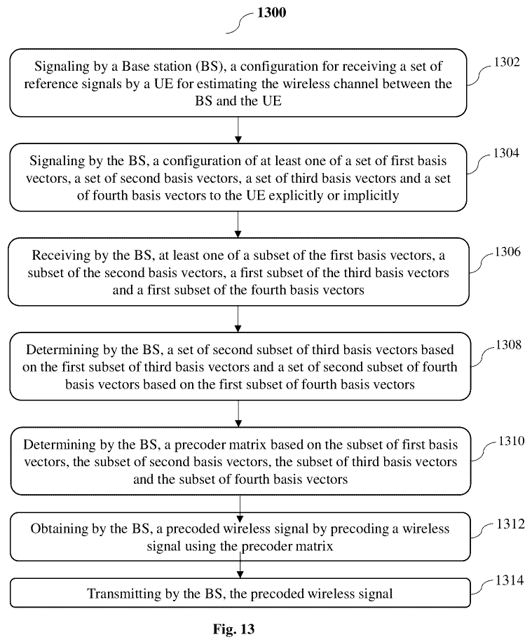

FIG. 13 illustrates a method 1300 of using a precoder matrix for wireless signal transmission in an OFDM based communication systems in accordance with an embodiment of the present disclosure. The method comprises: signaling 1302 by a Base station (BS), a configuration for receiving a set of reference signals by a UE for estimating the wireless channel between the BS and the UE, signaling 1304 by the BS, a configuration of at least one of a set of first basis vectors, a set of second basis vectors, a set of third basis vectors and a set of fourth basis vectors to the UE explicitly or implicitly, receiving 1306 by the BS, at least one of a subset of the first basis vectors, a subset of the second basis vectors, a first subset of the third basis vectors and a first subset of the fourth basis vectors, determining 1308 by the BS, a set of second subset of third basis vectors based on the first subset of third basis vectors and a set of second subset of fourth basis vectors based on the first subset of fourth basis vectors, determining 1310 by the BS, a precoder matrix based on the subset of first basis vectors, the subset of second basis vectors, the subset of third basis vectors and the subset of fourth basis vectors, obtaining 1312 by the BS, a precoded wireless signal by precoding the wireless signal using the precoder matrix and transmitting 1314 by the BS, the precoded wireless signal.

In an embodiment, configuration for receiving the set of reference signals comprises at least one of: a number of antenna ports at the BS, wherein an antenna port is associated with an antenna port index, the mapping between an antenna port index at the BS and a reference signal from the set of reference signals, wherein a reference signal from the set of reference signals is transmitted using the physical antenna elements associated with the antenna port, the dimension of the antenna panel at the BS comprising of the number of antenna ports in the first dimension (N₁), the number of antenna ports in the second dimension (N₂), an oversampling factor corresponding to the first dimension (O₁) and an oversampling factor corresponding to the second dimension (O₂), the number of sub-panels for precoder computation, the number of sub-panels in the first dimension

$$( {N}_{1}^{SP} )$$

and the number of sub-panels in the second dimension

$$( {N}_{2}^{SP} ) ,$$

wherein a sub-panel is associated with a sub-panel index, the reference sub-panel index among the set of sub-panel indices, the dimension of the at least one sub-panel at the BS comprising of the number of antenna ports per sub-panel in the first dimension

$$( {N}_{1}^{′} ) ,$$

the number of antenna ports per sub-panel in the second dimension

$$( {N}_{2}^{′} ) ,$$

an oversampling factor per sub-panel corresponding to the first dimension

$$( {O}_{1}^{′} )$$

and an oversampling factor sub-panel corresponding to the second dimension

$$( {O}_{2}^{′} ) ,$$

and the association between a subset of antenna port indices and a sub-panel index.

The BS determines the precoder corresponding to the reference sub-panel index based on the subset of first basis vectors, the subset of second basis vectors, the first subset of third basis vectors and the first subset of fourth basis vectors, wherein each second subset in the set of second subset of third basis vectors is associated with a sub-panel index and wherein each second subset in the set of second subset of fourth basis vectors is associated with a sub-panel index in accordance with an embodiment of the present disclosure.

Further, the BS determines the precoder corresponding to a sub-panel based on the subset of first basis vectors, the subset of second basis vectors, the second subset of third basis vectors associated with the sub-panel and the second subset of fourth basis vectors associated with the sub-panel.

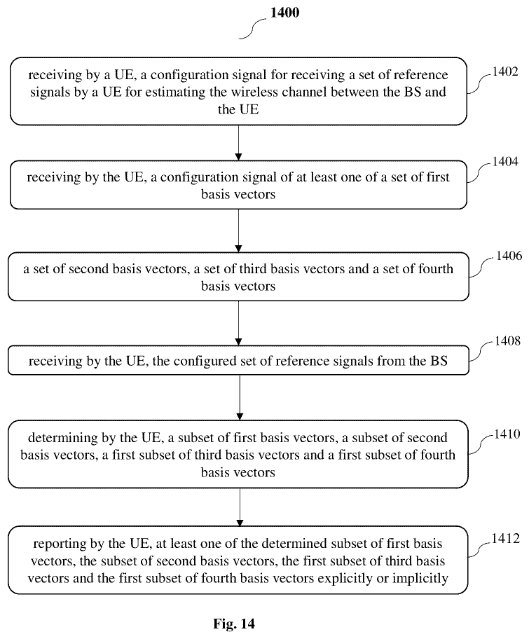

FIG. 14 illustrates a method 1400 of using a precoder matrix for wireless signal transmission in an OFDM based communication systems in accordance with another embodiment of the present disclosure. The method comprises: receiving 1402 by a UE, a configuration signal for receiving a set of reference signals by a UE for estimating the wireless channel between the BS and the UE, receiving 1404 by the UE, a configuration signal of at least one of a set of first basis vectors, a set of second basis vectors, a set of third basis vectors 1406 and a set of fourth basis vectors, receiving 1408 by the UE, the configured set of reference signals from the BS, determining 1410 by the UE, a subset of first basis vectors, a subset of second basis vectors, a first subset of third basis vectors and a first subset of fourth basis vectors and reporting 1412 by the UE, at least one of the determined subset of first basis vectors, the subset of second basis vectors, the first subset of third basis vectors and the first subset of fourth basis vectors explicitly or implicitly.

In an embodiment, the configuration for receiving the set of reference signals comprises at least one of: a number of antenna ports at the BS, wherein an antenna port is associated with an antenna port index, the mapping between an antenna port index at the BS and a reference signal from the set of reference signals, wherein a reference signal from the set of reference signals is transmitted using the physical antenna elements associated with the antenna port, the dimension of the antenna panel at the BS comprising of the number of antenna ports in the first dimension (N₁), the number of antenna ports in the second dimension (N₂), an oversampling factor corresponding to the first dimension (O₁) and an oversampling factor corresponding to the second dimension (O₂), the number of sub-panels for precoder computation, the number of sub-panels in the first dimension

$$( {N}_{1}^{SP} )$$

and the number of sub-panels in the second dimension

$$( {N}_{2}^{SP} ) ,$$

wherein a sub-panel is associated with a sub-panel index, the reference sub-panel index among the set of sub-panel indices, the dimension of the at least one sub-panel at the BS comprising of the number of antenna ports per sub-panel in the first dimension

$$( {N}_{1}^{′} ) ,$$

the number of antenna ports per sub-panel in the second dimension

$$( {N}_{2}^{′} ) ,$$

an oversampling factor per sub-panel corresponding to the first dimension

$$( {O}_{1}^{′} )$$

and an oversampling factor sub-panel corresponding to the second dimension

$$( {O}_{2}^{′} ) ,$$

and the association between a subset of antenna port indices and a sub-panel index.

The UE determines at least one of the set of first basis vectors, the set of second basis vectors based on at least one of N₁, N₂, N′₁, N′₂, O₁ and O₂. The UE determines at least one of the set of third basis vectors, the set of fourth basis vectors based on at least one of N′₁, N′₂, O′₁ and O′₂. The UE determines the subset of first basis vectors and the subset of second basis vectors based on the received set of reference signals. The UE further determines the first subset of third basis vectors and the first subset of fourth basis vectors based on the received set of reference signals corresponding to the reference sub-panel index.

In an embodiment, the UE reports the indices corresponding to the subset of first basis vectors, the indices corresponding to the subset of second basis vectors, the indices corresponding to the first subset of third basis vectors and the indices corresponding to the first subset of fourth basis vectors to the BS. The set of first basis vectors, the set of second basis vectors, the set of third basis vectors and the set of fourth basis vectors are DFT based vectors, wherein each second subset in the set of second subset of third basis vectors is associated with a sub-panel index and wherein each second subset in the set of second subset of fourth basis vectors is associated with a sub-panel index.

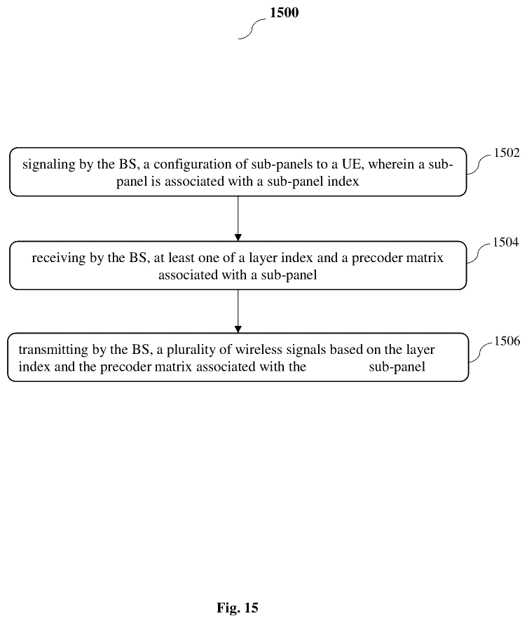

FIG. 15 illustrates a method 1500 for spatial multiplexing a plurality of wireless signals in an OFDM based wireless communication systems in accordance with another embodiment of the present disclosure. The method comprises: signaling 1502 by the BS, a configuration of sub-panels to a UE, wherein a sub-panel is associated with a sub-panel index, receiving 1504 by the BS, at least one of a layer index and a precoder matrix associated with a sub-panel and transmitting 1506 by the BS, a plurality of wireless signals based on the layer index and the precoder matrix associated with the sub-panel. The metric is computed based on at least one of a set of spatial domain (SD) basis vectors of a sub-panel, the signal to noise ratio (SINR) of a sub-panel, the sub-panel index and the cardinality of the plurality of wireless signals.

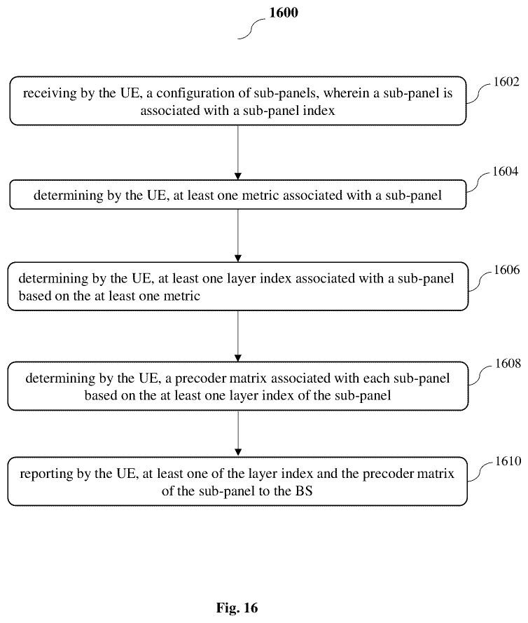

FIG. 16 illustrates a method 1600 for spatial multiplexing a plurality of wireless signals in an OFDM based wireless communication systems in accordance with another embodiment of the present disclosure. The method comprises: receiving 1602 by the UE, a configuration of sub-panels, wherein a sub-panel is associated with a sub-panel index, determining 1604 by the UE, at least one metric associated with a sub-panel, determining 1606 by the UE, at least one layer index associated with a sub-panel based on the at least one metric, determining 1608 by the UE, a precoder matrix associated with each sub-panel based on the at least one layer index of the sub-panel and reporting 1610 by the UE, at least one of the layer index and the precoder matrix of the sub-panel to the BS.

The metric is computed based on at least one of a set of spatial domain (SD) basis vectors of a sub-panel, the signal to noise ratio (SINR) associated with a sub-panel, the sub-panel index and the cardinality of the plurality of wireless signals. The UE determines the layer index between two sub-panels to be the same when at least K SD basis vectors are common between the two sub-panels in accordance with an embodiment of the present disclosure.

Embodiment of the present disclosure features an apparatus for using a precoder matrix for wireless signal transmission in an OFDM based communication systems comprising a processor, a memory storing program instructions which, when executed by the processor, causes the processor to: signal, a configuration for receiving a set of reference signals by a UE for estimating the wireless channel between the BS and the UE, signal, a configuration of at least one of a set of first basis vectors, a set of second basis vectors, a set of third basis vectors and a set of fourth basis vectors to the UE explicitly or implicitly, receive, at least one of a subset of the first basis vectors, a subset of the second basis vectors, a first subset of the third basis vectors and a first subset of the fourth basis vectors, determine, a set of second subset of third basis vectors based on the first subset of third basis vectors and a set of second subset of fourth basis vectors based on the first subset of fourth basis vectors, determine, a precoder matrix based on the subset of first basis vectors, the subset of second basis vectors, the subset of third basis vectors and the subset of fourth basis vectors, obtain, a precoded wireless signal by precoding a wireless signal using the precoder matrix and transmit, the precoded wireless signal.

Embodiment of the present disclosure features an apparatus for using a precoder matrix for wireless signal transmission in an OFDM based communication systems comprising: a processor, a memory storing program instructions which, when executed by the processor, causes the processor to: receive, a configuration signal for receiving a set of reference signals by a UE for estimating the wireless channel between the BS and the UE, receive, a configuration signal of at least one of a set of first basis vectors, a set of second basis vectors, a set of third basis vectors and a set of fourth basis vectors, receive, the configured set of reference signals from the BS, determine, a subset of first basis vectors, a subset of second basis vectors, a first subset of third basis vectors and a first subset of fourth basis vectors and report, at least one of the determined subset of first basis vectors, the subset of second basis vectors, the first subset of third basis vectors and the first subset of fourth basis vectors explicitly or implicitly.

Embodiment of the present disclosure features an apparatus for using a precoder matrix for wireless signal transmission in an OFDM based communication systems comprising: a processor, a memory storing program instructions which, when executed by the processor, causes the processor to: receive, at least one of a layer index and a precoder matrix associated with a sub-panel and transmit by the BS, a plurality of wireless signals based on the layer index and the precoder matrix associated with the sub-panel.

Embodiment of the present disclosure features an apparatus for using a precoder matrix for wireless signal transmission in an OFDM based communication systems comprising: a processor, a memory storing program instructions which, when executed by the processor, causes the processor to: receive, a configuration of sub-panels, wherein a sub-panel is associated with a sub-panel index, determine, at least one metric associated with a sub-panel, determine, at least one layer index associated with a sub-panel based on the at least one metric, determine, a precoder matrix associated with each sub-panel based on the at least one layer index of the sub-panel and report, at least one of the layer index and the precoder matrix of the sub-panel to the BS.

The figures of the disclosure are provided to illustrate some examples of the invention described. The figures are not to limit the scope of the depicted embodiments or the appended claims.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Embodiments of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various components/modules thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

We claim:

1. A method of using a precoder matrix for wireless signal transmission in an OFDM based communication systems, the method comprising:
signaling by a Base station (BS), a configuration for receiving a set of reference signals by a UE for estimating the wireless channel between the BS and the UE;
signaling by the BS, a configuration of at least one of a set of first basis vectors, a set of second basis vectors, a set of third basis vectors and a set of fourth basis vectors to the UE explicitly or implicitly;
receiving by the BS, at least one of a subset of the first basis vectors, a subset of the second basis vectors, a first subset of the third basis vectors and a first subset of the fourth basis vectors;
determining by the BS, a set of second subset of third basis vectors based on the first subset of third basis vectors and a set of second subset of fourth basis vectors based on the first subset of fourth basis vectors;
determining by the BS, a precoder matrix based on the subset of first basis vectors, the subset of second basis vectors, the subset of third basis vectors and the subset of fourth basis vectors;
obtaining by the BS, a precoded wireless signal by precoding a wireless signal using the precoder matrix; and
transmitting by the BS, the precoded wireless signal.

2. The method as claimed in claim 1, wherein the configuration for receiving the set of reference signals comprises at least one of:
a number of antenna ports at the BS, wherein an antenna port is associated with an antenna port index,
the mapping between an antenna port index at the BS and a reference signal from the set of reference signals, wherein a reference signal from the set of reference signals is transmitted using the physical antenna elements associated with the antenna port,
the dimension of the antenna panel at the BS comprising of the number of antenna ports in the first dimension (N₁), the number of antenna ports in the second dimension (N₂), an oversampling factor corresponding to the first dimension (O₁) and an oversampling factor corresponding to the second dimension (O₂),
the number of sub-panels for precoder computation, the number of sub-panels in the first dimension
$$( {N}_{1}^{SP} )$$
and the number of sub-panels in the second dimension
$$( {N}_{2}^{SP} ) ,$$
wherein a sub-panel is associated with a sub-panel index,
the reference sub-panel index among the set of sub-panel indices,
the dimension of the at least one sub-panel at the BS comprising of the number of antenna ports per sub-panel in the first dimension
$$( {N}_{1}^{′} ) ,$$
the number of antenna ports per sub-panel in the second dimension
$$( {N}_{2}^{′} ) ,$$
an oversampling factor per sub-panel corresponding to the first dimension
$$( {O}_{1}^{′} )$$
and an oversampling factor sub-panel corresponding to the second dimension
$$( {O}_{2}^{′} ) ,$$
and
the association between a subset of antenna port indices and a sub-panel index.

3. The method as claimed in claim 1, wherein the BS determines the precoder corresponding to the reference sub-panel index based on the subset of first basis vectors, the subset of second basis vectors, the first subset of third basis vectors and the first subset of fourth basis vectors.

4. The method as claimed in claim 2, wherein each second subset in the set of second subset of third basis vectors is associated with a sub-panel index.

5. The method as claimed in claim 2, wherein each second subset in the set of second subset of fourth basis vectors is associated with a sub-panel index.

6. The method as claimed in claim 5, wherein the BS determines the precoder corresponding to a sub-panel based on the subset of first basis vectors, the subset of second basis vectors, the second subset of third basis vectors associated with the sub-panel and the second subset of fourth basis vectors associated with the sub-panel.

7. A method of using a precoder matrix for wireless signal transmission in an OFDM based communication systems, the method comprising:
receiving by a UE, a configuration signal for receiving a set of reference signals by a UE for estimating the wireless channel between the BS and the UE;
receiving by the UE, a configuration signal of at least one of a set of first basis vectors;
a set of second basis vectors, a set of third basis vectors and a set of fourth basis vectors;
receiving by the UE, the configured set of reference signals from the BS;
determining by the UE, a subset of first basis vectors, a subset of second basis vectors, a first subset of third basis vectors and a first subset of fourth basis vectors; and
reporting by the UE, at least one of the determined subset of first basis vectors, the subset of second basis vectors, the first subset of third basis vectors and the first subset of fourth basis vectors explicitly or implicitly.

8. The method as claimed in claim 7, wherein the configuration for receiving the set of reference signals comprises at least one of:
a number of antenna ports at the BS; wherein an antenna port is associated with an antenna port index,
the mapping between an antenna port index at the BS and a reference signal from the set of reference signals, wherein a reference signal from the set of reference signals is transmitted using the physical antenna elements associated with the antenna port,
the dimension of the antenna panel at the BS comprising of the number of antenna ports in the first dimension (N₁), the number of antenna ports in the second dimension (N₂), an oversampling factor corresponding to the first dimension (O₁) and an oversampling factor corresponding to the second dimension (O₂),
the number of sub-panels for precoder computation, the number of sub-panels in the first dimension
$$( {N}_{1}^{SP} )$$
and the number of sub-panels in the second dimension
$$( {N}_{2}^{SP} ) ,$$
wherein a sub-panel is associated with a sub-panel index,
the reference sub-panel index among the set of sub-panel indices,
the dimension of the at least one sub-panel at the BS comprising of the number of antenna ports per sub-panel in the first dimension
$$( {N}_{1}^{′} ) ,$$
the number of antenna ports per sub-panel in the second dimension
$$( {N}_{2}^{′} ) ,$$
an oversampling factor per sub-panel corresponding to the first dimension
$$( {O}_{1}^{′} )$$
and an oversampling factor sub-panel corresponding to the second dimension
$$( {O}_{2}^{′} ) ,$$
and
the association between a subset of antenna port indices and a sub-panel index.

9. The method as claimed in claim 8, wherein the UE determines at least one of the set of first basis vectors, the set of second basis vectors based on at least one of N₁, N₂, N′₁, N′₂, O₁ and O₂.

10. The method as claimed in claim 8, wherein the UE determines at least one of the set of third basis vectors, the set of fourth basis vectors based on at least one of N′₁, N′₂, O′₁ and O′₂.

11. The method as claimed in claim 8, wherein the UE determines the subset of first basis vectors and the subset of second basis vectors based on the received set of reference signals.

12. The method as claimed in claim 8, wherein the UE determines the first subset of third basis vectors and the first subset of fourth basis vectors based on the received set of reference signals corresponding to the reference sub-panel index.

13. The method as claimed in claims 11 and 12, wherein the UE reports the indices corresponding to the subset of first basis vectors, the indices corresponding to the subset of second basis vectors, the indices corresponding to the first subset of third basis vectors and the indices corresponding to the first subset of fourth basis vectors to the BS.

14. The method as claimed in claims 9 and 10, wherein the set of first basis vectors, the set of second basis vectors, the set of third basis vectors and the set of fourth basis vectors are DFT based vectors.

15. The method as claimed in claim 8, wherein each second subset in the set of second subset of third basis vectors is associated with a sub-panel index.

16. The method as claimed in claim 8, wherein each second subset in the set of second subset of fourth basis vectors is associated with a sub-panel index.

17. A method for spatial multiplexing a plurality of wireless signals in an OFDM based wireless communication systems, the method comprising:
signaling by the BS, a configuration of sub-panels to a UE, wherein a sub-panel is associated with a sub-panel index;
receiving by the BS, at least one of a layer index and a precoder matrix associated with a sub-panel; and
transmitting by the BS, a plurality of wireless signals based on the layer index and the precoder matrix associated with the sub-panel.

18. The method as claimed in claim 17, wherein the metric is computed based on at least one of a set of spatial domain (SD) basis vectors of a sub-panel, the signal to noise ratio (SINR) of a sub-panel, the sub-panel index and the cardinality of the plurality of wireless signals.

19. A method for spatial multiplexing a plurality of wireless signals in an OFDM based wireless communication systems, the method comprising:
receiving by the UE, a configuration of sub-panels, wherein a sub-panel is associated with a sub-panel index;
determining by the UE, at least one metric associated with a sub-panel;
determining by the UE, at least one layer index associated with a sub-panel based on the at least one metric;
determining by the UE, a precoder matrix associated with each sub-panel based on the at least one layer index of the sub-panel; and
reporting by the UE, at least one of the layer index and the precoder matrix of the sub-panel to the BS.

20. The method as claimed in claim 19, wherein the metric is computed based on at least one of a set of spatial domain (SD) basis vectors of a sub-panel, the signal to noise ratio (SINR) associated with a sub-panel, the sub-panel index and the cardinality of the plurality of wireless signals.

21. The method as claimed in claim 20, wherein the UE determines the layer index between two sub-panels to be the same when at least K SD basis vectors are common between the two sub-panels.

22. An apparatus for using a precoder matrix for wireless signal transmission in an OFDM based communication systems comprising:
a processor;
a memory storing program instructions which, when executed by the processor, causes the processor to:
signal, a configuration for receiving a set of reference signals by a UE for estimating the wireless channel between the BS and the UE;
signal, a configuration of at least one of a set of first basis vectors, a set of second basis vectors, a set of third basis vectors and a set of fourth basis vectors to the UE explicitly or implicitly;
receive, at least one of a subset of the first basis vectors, a subset of the second basis vectors, a first subset of the third basis vectors and a first subset of the fourth basis vectors;
determine, a set of second subset of third basis vectors based on the first subset of third basis vectors and a set of second subset of fourth basis vectors based on the first subset of fourth basis vectors;
determine, a precoder matrix based on the subset of first basis vectors, the subset of second basis vectors, the subset of third basis vectors and the subset of fourth basis vectors;
obtain, a precoded wireless signal by precoding a wireless signal using the precoder matrix; and
transmit, the precoded wireless signal.

23. An apparatus for using a precoder matrix for wireless signal transmission in an OFDM based communication systems comprising:
a processor;
a memory storing program instructions which, when executed by the processor, causes the processor to:
receive, a configuration signal for receiving a set of reference signals by a UE for estimating the wireless channel between the BS and the UE;
receive, a configuration signal of at least one of a set of first basis vectors;
a set of second basis vectors, a set of third basis vectors and a set of fourth basis vectors;
receive, the configured set of reference signals from the BS;
determine, a subset of first basis vectors, a subset of second basis vectors, a first subset of third basis vectors and a first subset of fourth basis vectors; and
report, at least one of the determined subset of first basis vectors, the subset of second basis vectors, the first subset of third basis vectors and the first subset of fourth basis vectors explicitly or implicitly.

24. An apparatus for using a precoder matrix for wireless signal transmission in an OFDM based communication systems comprising:
a processor;
a memory storing program instructions which, when executed by the processor, causes the processor to:
receive, at least one of a layer index and a precoder matrix associated with a sub-panel; and
transmit by the BS, a plurality of wireless signals based on the layer index and the precoder matrix associated with the sub-panel.

25. An apparatus for using a precoder matrix for wireless signal transmission in an OFDM based communication systems comprising:
a processor;
a memory storing program instructions which, when executed by the processor, causes the processor to:
receive, a configuration of sub-panels, wherein a sub-panel is associated with a sub-panel index;
determine, at least one metric associated with a sub-panel;
determine, at least one layer index associated with a sub-panel based on the at least one metric;
determine, a precoder matrix associated with each sub-panel based on the at least one layer index of the sub-panel; and
report, at least one of the layer index and the precoder matrix of the sub-panel to the BS.
